(19) United States
(12) Patent Application Publication
(10) Pub. No.: US 2026/0089049 A1
(43) Pub. Date: Mar. 26, 2026

(54) Split Brain Systems Control during Network Interruption

(71) Applicant: PassiveLogic, Inc., Holladay, UT (US)

(72) Inventors: Troy Aaron Harvey, Holladay, UT (US); Jeremy David Fillingim, Salt Lake City, UT (US); Austin Payne, Sandy, UT (US)

(21) Appl. No.: 18/896,241

(22) Filed: Sep. 25, 2024

(51) Int. Cl. H04L 41/06; H04L 67/12

(52) U.S. Cl. CPC H04L 41/06; H04L 67/12

(57) ABSTRACT

Various embodiments relate to a method, apparatus, and machine-readable storage medium including one or more of the following: receiving word of a network failure; receiving election as leader of a partition; determining subsystems completely in the partition; starting control processes for equipment in the subsystems completely in partition; and starting sensor processes for equipment in the subsystems completely in partition.

### TECHNICAL FIELD

Various embodiments described herein relate to systems with multiple controllers and more particularly, but not exclusively, to handling network interruptions in a system with multiple controllers.

### BACKGROUND

When controlling a distributed system using a network, network interruptions will generally stop the controller from communicating with the devices it intends to control. While distributed control systems exist with multiple controllers, these systems typically have one leader controller to ensure that issued controls make sense at the system-wide level. Thus, a network interruption will drastically impact a leader's ability to provide system-wide direction. Though a system portion without a controller may continue to execute instructions that were previously issued before the failure, system-wide changes in operation will not be possible until the network interruption is restored. Whatever part of the system that cannot be reached by the leader typically is down until the network interruption has been fixed. Worse, in some cases, a network partition can lead to a split-brain scenario, where each segment believes it is the only functioning part of the network. This can result in divergent configurations, data inconsistencies, and conflicts when the partitions are merged, which may lead to serious instabilities in the underlying system. A way to be able to recover more of the system and minimize or stop such divergencies, inconsistencies, and conflicts would improve distributed system reliability, productivity, efficiency, security, and would save costs.

### SUMMARY

Accordingly, there exists a need for methods and systems for allowing split brain systems to operate efficiently without corrupting underlying data, and while allowing the various partitions to run optimally. One way this is done is by dividing the system up into subsystems and ensuring that each subsystem run during a network interruption is only run if the entire subsystem may be run on a single network partition, or in some embodiments, on a single controller. Accordingly, various embodiments described herein relate to a self-healing split brain system that controlling at least a portion of a system with a network failure, including one or more of the following: receiving word of a network failure; receiving election as leader of a partition; determining subsystems completely in the partition; starting control processes for equipment in the subsystems completely in partition; and starting sensor processes for equipment in the subsystems completely in partition.

Various embodiments are described herein where determining subsystems completely in partition further includes using a digital twin database stored within the controller to determine subsystems.

Various embodiments are described herein where determining subsystems completely in partition includes determining controllers that can be communicated with.

Various embodiments are described herein where determining subsystems completely in partition may further include determining subsystems within the controllers that can be communicated with creating determined subsystems.

Various embodiments are described herein where determining subsystems completely in partition may include determining subsystems whose devices are on a single controller, creating determined subsystems.

Various embodiments are described herein where areas in a controllable space are determined that can be controlled by the controller.

Various embodiments are described herein further including determining comfort levels for the areas in the controllable space that can be controlled by the controller.

Various embodiments are described herein including determining control paths for the areas in the controllable space that can be controlled by the controller.

Various embodiments are described herein including starting a control processes associated with the determined subsystems.

Various embodiments are described herein including starting a sensor processes within the determined subsystems.

Various embodiments additionally include a device for controlling at least a portion of a system with a network failure, including one or more of: a memory storing a digital twin representing a physical space; and a processor configured to: receive word of a network failure; receive election as leader of a partition; determine subsystems completely in the partition; start control processes for equipment in the subsystems completely in partition; and start sensor processes for equipment in the subsystems completely in partition.

Additionally, various embodiments include a non-transitory machine-readable medium encoded with instructions for execution by a processor for capturing digital twin information performed by a processor, the non-transitory machine-readable medium including at least one of: instructions for receiving word of a network failure; instructions for receiving election as leader of a partition; instructions for determining subsystems completely in the partition; instructions for starting control processes for equipment in the subsystems completely in partition; and instructions for starting sensor processes for equipment in the subsystems completely in partition.

### BRIEF DESCRIPTION OF THE DRAWINGS

In order to better understand various example embodiments, reference is made to the accompanying drawings, wherein:

FIG. 1 illustrates an example system for implementation of various embodiments;

FIG. 2 illustrates an example distributed computing system environment for deployment of various embodiments;

FIG. 3 illustrates an example digital twin for use in various embodiments;

FIG. 4 illustrates an example system for use in various embodiments;

FIG. 5 illustrates an example system for use in various embodiments;

FIGS. 6A-6C illustrate example subsystems for use in various embodiments;

FIG. 7 illustrates example network error detection types;

FIG. 8 illustrates an example method for implementing a split brain self-healing system;

FIG. 9 illustrates an example partitioned system;

FIG. 10 illustrates example subsystems attached to example controllers;

FIG. 11 illustrates an example database schema; and

FIG. 12 illustrates an example system for implementing a split-brain system.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or” refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

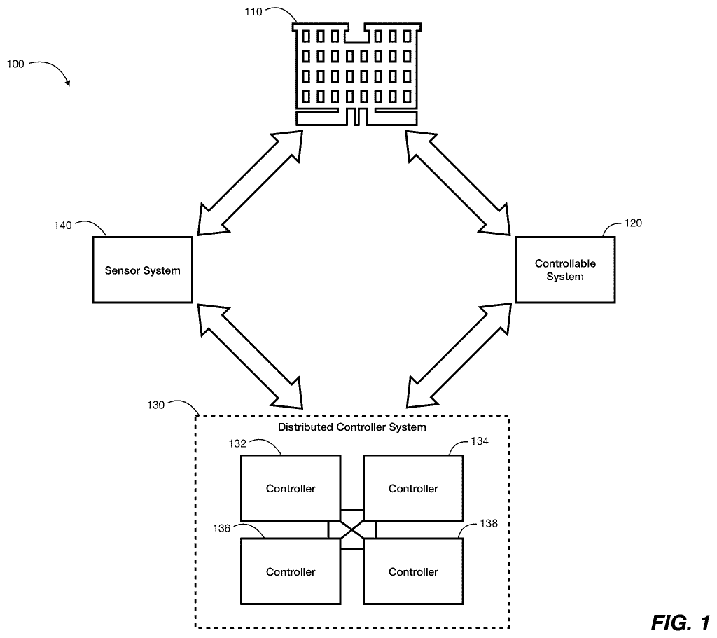

FIG. 1 illustrates an example system 100 for implementation of various embodiments. As shown, the system 100 may include an environment 110, some aspect of which is affected by a controllable system 120. The behavior of the controllable system 120 is, in turn, controlled by a distributed controller system 130. To obtain information useful in making control decisions, the distributed controller system 130 receives data from a sensor system 140 which, in turn, generates its data based on observations from the environment 110.

According to one specific example, system 100 may describe a heating, ventilation, and air conditioning (HVAC) application. As such the environment 110 may be a building whose temperature is to be controlled by the controllable system 120. The controllable system 120 may be the HVAC system itself, which may be controllable to distribute warm or cool air throughout the building 110. Thus, the controllable system 120 may include HVAC equipment such as pumps, boilers, radiators, chillers, fans, vents, etc. The sensor system 140 may include a set of temperature sensors distributed throughout the building 110 to collect and report temperature values.

While various embodiments disclosed herein will be described in the context of such an HVAC application, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied to other applications outside the context of controlled systems. Various modifications to adapt the teachings and embodiments to use in such other applications will be apparent.

As shown, the distributed controller system 130 includes four controllers 132, 134, 136, 138 in communication with one another. The controllers 132, 134, 136, 138 may be located within the environment 110, at another location (such as another environment similar to the environment 110 or in a cloud data center), or some combination thereof. Each controller 132, 134, 136, 138 may be connected to one or more devices, such as individual devices of the controllable system 120 or sensor system 140. Such connection may be direct or indirect (e.g., via one or more intermediate devices such as a network), wired or wireless, or any other type of connection that would enable communication between devices. In some embodiments, each controller 132, 134, 136, 138 may be connected to those devices of the controllable system 120 or sensor system 140 that are physically most proximate to that respective controller 132, 134, 136, 138. For example, where the environment 110 is a building with four floors, the controllers 132, 134, 136, 138 may be installed one on each such floor and then connected to the devices of the controllable system 120 or sensor system 140 physically located on the same floor. Alternatively, devices of the controllable system 120 may be distributed amongst controllers 132, 134, 136, 138 via criteria other than physical proximity, such as demand of the devices on the each controller 132, 134, 136, 138.

The controllers 132, 134, 136, 138 may be identical to each other or may employ different hardware or software. For example, two controllers 132, 134 may be full featured controllers while the other two controllers 136, 138 may be satellite controllers with limited capabilities with respect to the full featured controllers. As another example, one or more of the controllers 132, 134, 136, 138 may be specialized in one or more respects, deployed to work on only a subset of tasks associated with controlling the controllable system 120. As such, the controllers 132, 134, 136, 138 may implement partial or full redundancy of functionality or may divide functionality among themselves (either by pre-installation component design or by post-installation coordination or agreement) to achieve a fully functional distributed controller system 130. While the teachings and embodiments disclosed herein will be described with respect to fully-redundant, fully-featured controllers 132, 134, 136, 138 (unless otherwise noted), modifications for applications of the teachings and embodiments for application to such alternative controller 132, 134, 136, 138 arrangements will be apparent. It will also be apparent that other embodiments may include a greater or fewer number of controllers. In some such embodiments, the system 100 may include only a single controller, rather than multiple controllers cooperating in a distributed manner. Various modifications in such alternative embodiments will be apparent.

Various methods for implementing a distributed controller system 130 may be employed for coordinating the functions of the controllers 132, 134, 136, 138. For example, the controllers 132, 134, 136, 138 may coordinate to elect a single controller 132, 134, 136, 138 to take the function of leader controller, while the remaining controllers 132, 134, 136, 138 become follower controllers. In such an arrangement, each follower controller may perform some limited functionality, such as receiving sensor data from those devices in the sensor system 140 attached to that follower controller, committing such sensor data 226 to a database available to the other controllers 132, 134, 136, 138, ensuring proper connections and operation of devices of the controllable system 120 attached to that follower controller, performing fault detection for one or more field devices 296, or calculating derived “sensor” or otherwise predicting data for areas or components where direct observation (e.g., via a physical sensor device) is not possible.

Meanwhile, the elected leader controller may be responsible for additional functionality such as, for example, training machine learning models, running simulations, and making control decisions for the controllable system 120. In some embodiments, the elected leader controller may rely on the remaining controllers 132, 134, 136, 138 to assist in the performance of these tasks by distributing work among the follower controllers according to various distributed work paradigms that may be employed. For example, the leader controller may break a task to be performed into multiple smaller steps or work packages, transmit the steps or work packages to the follower controllers for performance, receive the sub-results of the steps or work packages back when the work is completed, and use the sub-results to arrive at an ultimate result (e.g., a further trained model, a completed simulation or set of simulations, or a control decision). With regard to control decisions or other actions involving communication with devices of the controllable system 120 or the sensor system 140, the leader controller may determine to which of the controllers 132, 134, 136, 138 the device is connected and send the communication to that controller 132, 134, 136, 138 to then be passed on to the intended device.

It will be understood that FIG. 1 may represent a simplification in some respects. For example, in some embodiments, one or more devices may be both a controllable device (belonging to the controllable system 120) and a sensor device (belonging to the sensor system 140). For example, a controllable pump may have an integrated sensor that reports an observed pressure back to the distributed controller system 130. In some embodiments, there may be multiple controllable systems 120, multiple sensor systems 140, or other systems (not shown) involved in implementing the overall system 100, each of which may or may not be in communication with the distributed controller system 130. For example, the distributed controller system 130 may control both an HVAC system and a lighting system, which may be implemented as two independent controllable systems 120. As another example, the distributed controller system 130 may obtain sensor data from both a set of sensors the distributed controller system 130 manages as well as a set of sensors managed by a third party service (e.g., as may be made available through an API or other network-based service) and, as such, there may be multiple independent sensor systems 140 that inform the operation of the distributed controller system 130. In some embodiments, the distributed controller system 130 may manage controllable systems 120 for multiple environments 110 (e.g., the HVAC systems for two or more separate buildings) or may be in communication with other distributed controller systems 130 associated with implementations of systems similar to system 100 for other environments 110 (e.g., to extend the processing capacity through distribution of work to additional controllers, to execute multi-building control actions, or to gather information from other environments such as predicted power usage). Thus, where the environment 110 is a building, one or more distributed controller systems 130 may implement not only a “smart building” but a “smart city” of multiple buildings coordinating their operations. Various modifications for replicating or otherwise adapting the teachings herein across additional environments, controllable systems, distributed controller systems, or sensor systems will be apparent.

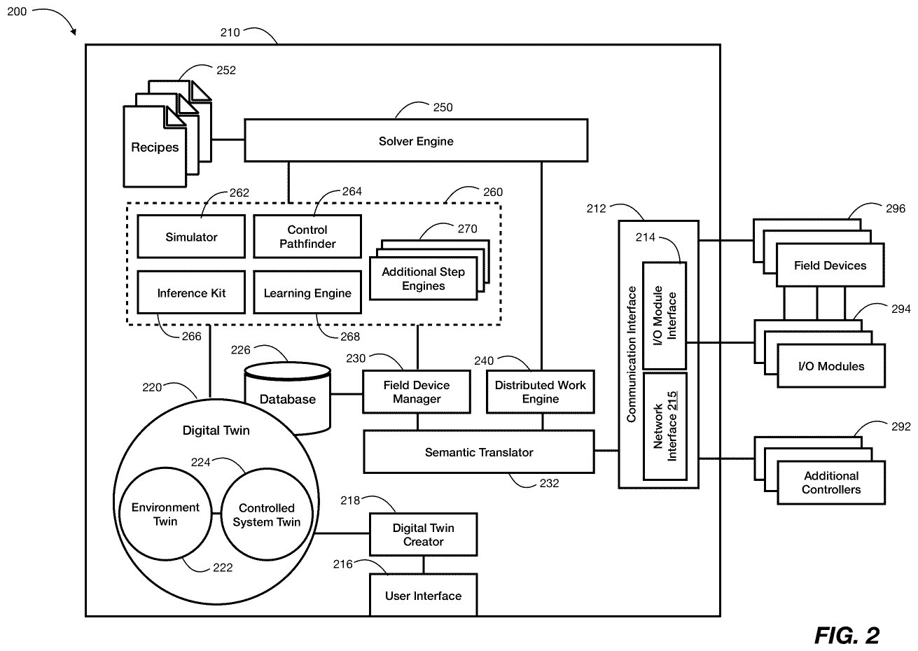

FIG. 2 illustrates an example system 200 for implementing a controller device 210. The controller device 210 may correspond to one of the controllers 132, 134, 136, 138 of the example system 100 and, as such, may communicate with additional controllers 292 (which may correspond to the remaining controllers 132, 134, 136, 138) to implement a distributed controller system such as the distributed controller system 130. In other embodiments, where only a single controller 210 is used, the additional controllers 292 may not be present. In some embodiments, the controller 210 may be or include a building automation system (BAS) or building management system (BMS).

The controller 210 also communicates with multiple field devices 296. These field devices 296 may correspond to one or more devices belonging to the controllable system 120 or sensor system 140 of the example system 100. Similarly, other field devices 296 may communicate with the additional controllers 292. As such, the field devices 296 may include devices that may be controlled to affect some state of an environment (e.g., HVAC equipment that cooperate to manage a building temperature) or sensor devices that report back information about the environment (e.g., temperature sensors deployed among the different environmental zones of the building).

As noted above, virtually any connection medium (or combination of media) may be used to enable communication between the controller 210 and the additional controllers 292 or field devices 296, including wired, wireless, direct, or indirect (i.e., through one or more intermediary devices, such as in a network) connections. As used herein, the term “connected” as used between two devices will be understood to encompass any form of communication capability between those devices. To enable such connections, the controller 210 includes a communications interface 212. As will be explained in greater detail below, the communication interface 212 may include virtually any hardware for enabling connections with additional controllers 292 or field devices 296, such as an Ethernet network interface card (NIC), WiFi NIC, or USB connection.

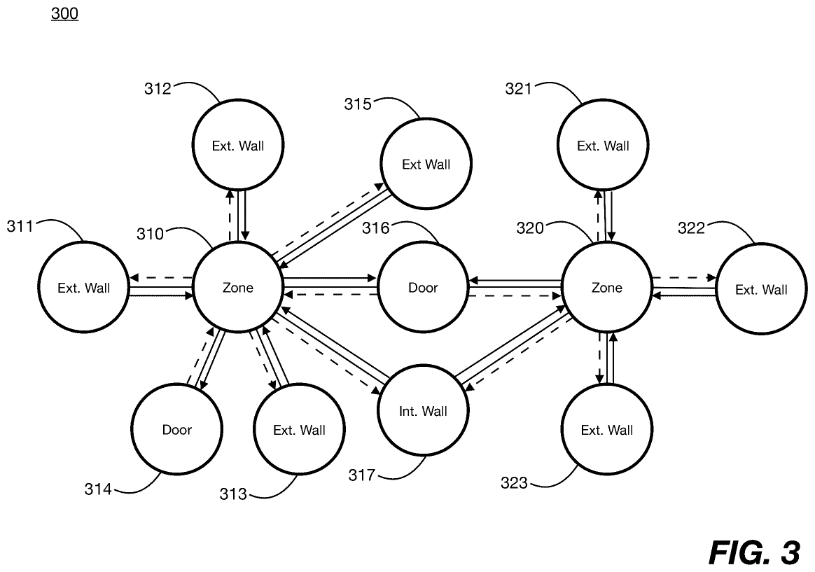

In some embodiments, one or more connections to other devices may be supported by one or more I/O modules 294. The I/O modules 294 may provide further hardware or software used in controlling or otherwise communicating with field devices 296 having specific protocols or other particulars for such communication to occur. For example, where a field device 296 includes a motor to be controller, an I/O module 294 having components such as a motor control block, motor drivers, pulse width modulation (PWM) control, or other components relevant to motor control may be used to connect that field device 296 to the controller 210. Various additional components for inclusion in different I/O modules 294 for control of different particular field devices 296. Additional features, such as current or voltage monitoring or overcurrent protection may also be incorporated into the I/O modules 294. To enable communication with the I/O modules 294, the communication interface 212 may include an I/O module interface 214. In various embodiments, the I/O module interface 214 may be a set of electrical contacts for contact with complementary pins of the I/O modules 294. A communication protocol, such as USB, may be implemented over such contacts and pins to enable passing of information between the controller 210 and I/O modules 294. In other embodiments, the I/O module interface 314 may include the same interfaces previously described with respect to the communication interface. In various alternative embodiments, on the other hand, some or all of these more particular components may be incorporated into the controller 210 itself, and some or all of the I/O modules 294 may be omitted from the system 200. Various additional techniques for implementing an I/O module 294 according to various embodiments, may be described in U.S. Pat. Nos. 11,229,138; and 11,706,891, the entire disclosures of which are hereby incorporated herein by reference. According to various embodiments, a network interface According to various embodiments, the controller 210 utilizes a digital twin 220 that models at least a portion of the system it controls and may be stored in a database 226 along with other data. As shown, the digital twin 220 includes an environment twin 222 that models the environment whose state is being controlled (e.g., a building) and a controlled system twin 224 that models the system that the controller 210 controls (e.g., an HVAC equipment system). A digital twin 220 may be any data structure that models a real-life object, device, system, or other entity. Examples of a digital twin 220 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins. Further, while the environment twin 222 and controlled system twin 224 are shown as separate structures, in various embodiments, these twins 222, 224 may be more fully integrated as a single digital twin 220. In some embodiments, additional systems, entities, devices, processes, or objects may be modeled and included as part of the digital twin 220.

In various embodiments, a user may create or modify the digital twin 220. In such embodiments, the controller 210 may include a user interface 216 through which the user accesses a digital twin creator 218 to create or modify the digital twin 220. For example, the user interface 216 may include a display, a touchscreen, a keyboard, a mouse, or any device capable of performing input or output functions for a user. In some embodiments, the user interface 216 may instead or additionally allow a user to use another device for such input or output functions, such as connecting a separate tablet, mobile phone, or other device for interacting with the controller 210.

The digital twin creator 218 may provide a toolkit for the user to create digital twins 220 or portions thereof. For example, the digital twin creator 218 may include a tool for defining the walls, doors, windows, floors, ventilation layout, and other aspects of a building construction to create the environment twin 222. The tool may allow for definition of properties useful in defining a digital twin 220 (e.g., for running a physics simulation using the digital twin 220) such as, for example, the materials, dimensions, or thermal characteristics of elements such as walls and windows. Such a tool may resemble a computer-aided drafting (CAD) environment in many respects. According to various embodiments, unlike typical CAD tools, the digital twin creator 218 may digest the defined building structure into a digital twin 220 model that may be computable, trainable, inferenceable, and queryable, as will be described in greater detail below.

In addition or alternative to building structure, the digital twin creator 218 may provide a toolkit for defining virtually any system that may be modeled by the digital twin 220. For example, for creating the controlled system twin 224, the digital twin creator 218 may provide a drag-and-drop interface where various HVAC equipment (e.g., boilers, pumps, valves, tanks, etc.) may be placed and connected to each other, forming a system (or a group of systems) that reflect the real world controllable system 120. In some embodiments, the digital twin creator 218 may drill even further down into definition of twin elements by, for example, allowing the user to define individual pieces of equipment (along with their behaviors and properties) that may be used in the definition of systems. As such, the digital twin creator 218 provides for a composable twin, where individual elements may be “clicked” together to model higher order equipment and systems, which may then be further “clicked” together with other elements.

In other embodiments, the digital twin 220 may be created by another device (e.g., by a server providing a web- or other software-as-a-service (SaaS) interface for the user to create the digital twin 220, or by a device of the user running such software locally) and later downloaded to or otherwise synced to the controller 210. In other embodiments, the digital twin 220 may be created automatically by the controller 210 through observation of the systems it controls or is otherwise in communication with. In some embodiments a combination of such techniques may be employed to produce an accurate digital twin-a first user may initially create a digital twin 220 using a SaaS service, the digital twin 220 may be downloaded to the controller 210 where a second user further refines or extends the digital twin 220 using the digital twin creator 218, and the controller 210 in operation may adjust the digital twin 220 as needed to better reflect the real observations from the systems it communicates with. Various additional techniques for defining, digesting, compiling, and utilizing a digital twin 220 according to some embodiments may be described in U.S. Pat. Nos. 10,708,078; and 10,845,771; and U.S. patent application publication numbers 2021/0383200; 2021/0383235; and 2022/0215264, the entire disclosures of which are hereby incorporated herein by reference.

In addition to storing the digital twin 220, the database 226 may store additional information that is used by the controller 210 to perform its functions. For example, the database 226 may hold tables that store sensor data collected from field devices 296 or control actions that should be issued to field devices 296. Various additional or alternative information for storage in the database 226 will be apparent. In various embodiments, the database 226 implements database replication techniques to ensure that the database 226 content is made available to the additional controllers 292. As such, changes that the controller 210 makes to the database 226 content (including the digital twin 220) may be made available to each of the controllers 292, while database changes made by the additional controllers 292 are similarly made available in the database 226 of the controller 210 as well as the other additional controllers 292.

A field device manager 230 may be responsible for initiating and processing communications with field devices 296, whether via I/O modules 294 or not. As such the field device manager 230 may implement multiple functions. For sensor management, the device manager 230 may receive (via the communication interface 212 and semantic translator 232) reports of sensed data. The field device manager 230 may then process these reports and place the sensed data in the database 226 such that it is available to the other components of the controller 210. In managing sensor devices, the field device manager 230 may be configured to initiate communications with the sensor devices to, for example, establish a reporting schedule for the sensor devices and, where the sensor devices form a network for enabling such communications, the network paths that each sensor device will use for these communications. In some embodiments, the field device manager 230 may receive (e.g., as part of sensor device reports) information about the sensor health and then use this information to adjust reporting schedule or the network topology. For example, where a sensor device reports low battery or low power income, the controller 210 may instruct that sensor device to report less frequently or to move to a leaf node of the network topology so that its power is not used to perform the function of routing messages for other sensors with a better power state. Various other techniques for managing a group or swarm of sensor devices will be apparent.

The field device manager 230 may also be responsible for managing and verify the connections of field devices 296 to the I/O modules 294. For example, configuration data stored in the digital twin 220 or elsewhere in the database 226 may indicate that a particular field device 296 is expected to be connected to a particular I/O module 294 having a particular set of supporting components, that the particular I/O module 294 is expected to be connected to a particular I/O module interface 214, and that communications through the particular I/O module 294 are expected to occur according to a particular set of protocols. The field device manager 230 may test (e.g., by sending one or more test communications) that the particular field device 296 is actually set up according to these configurations (e.g., if communications are successful or not) and then take remedial action if there is an installation problem. In some cases, the field device manager 230 may simply update the configuration information if doing so will solve the incorrect installation (e.g. the I/O module 294 is connected to a different I/O module interface 214 but is otherwise working, the I/O module 294 is configured to communicate according to a different protocol). In other cases, the field device manager 230 may prompt a user that these is an issue with the connection and ask for the user to take remedial action (e.g., reconfigure settings at the controller 210 or physically relocate, replace, or otherwise reinstall an I/O module 294, connection wires, or the field device 296). As such, the field device manager 230 in some embodiments provides a software toolset for the user via the user interface 216, a web portal, or elsewhere. In some embodiments, such a user interface 216 may be a graphical representation of the controller 210, I/O modules 294, and field device 296 connections thereto that allows the user to see how these devices are expected by the controller 210 to be installed. In some embodiments, the toolset may also allow the user to reconfigure these expectations rather than physically changing the system of devices (e.g., by dragging an I/O module graphic to a different connection graphic, or by changing a connection type for one or more wiring terminal graphics of an I/O module graphic).

In some embodiments, the communication interface 212 may also include a network interface 215. This network interface may be used to connect the additional controllers 292 to the communications interface 212. The network interface 215 may be used to communicate as part of the distributed controller system 130. For example, the different controllers 132, 134, 136, 138 may be independent computing entities that communicate by with each other using a network interface 215 that connects to a distributed controller system network. This network may facilitate communication, coordination, and resource sharing among the controllers, making it possible for the distributed controller system to function as a cohesive unit. For example, in some embodiments, when there is a fault with the network in the distributed controller system 130, the network interface may be able to connect with the network, determine which controllers can still be reached from this controller 200, and determine which field devices associated with the additional controllers 292 may be able to be reached from this network interface 215.

In some embodiments, in addition to the verification of I/O module 294 connections, the field device manager 230 may perform a fuller commissioning procedure. For example, the field device manager 230 may perform a series of tests on the field devices 296 that are connected to the controller 210 or on the full set of field devices 296 in the controllable system 120 or the sensor system 140 (particularly where the controller 210 has been elected as a leader controller). Accordingly, in some such embodiments, the field device manager 230 may communicate with the field devices 296 via the communication interface 212 to perform tests to verify that installation and behavior is as expected (e.g., as expected from simulations run against the digital twin 220 or from other configurations stored in the database 226 or otherwise available to the controller 210). Where the field device manager 230 drives testing of field devices 296 attached instead to one or more additional controllers 292, the testing may include communication with the additional controllers 292 (e.g., through use of the distributed work engine 240 or directly through the communications interface 212), such as test messages that the additional controllers 292 route to their connected field devices 296 or instructions for the additional controllers 292 to perform testing themselves and report results thereof.

In some embodiments, the testing performed by the field device manager 230 may be defined in a series of scripts, preprogrammed algorithms, or driven by artificial intelligence (examples of which will be explained below). Such tests may be very simple (e.g., “can a signal be read on a wire,” or “does the device respond to a simple ping message”), device specific (e.g., “is the device reporting errors according to its own testing,” “is the device reporting meaningful data,” “does the device successfully perform a test associated with its device type”), driven by the digital twin 220 (“does this device report expected data or performance when this other equipment is controlled in this way,” “when the device is controlled this way, do other devices report expected data”), at a higher system level (“does this zone of the building operate as expected,” “do these two devices work together without error”), or may have any other characteristics for verifying proper installation and functioning of a number of devices both individually and as part of higher order systems.

In some embodiments, a user may be able to define (e.g., via the user interface 216) at least some of the commissioning tests to be performed. In some embodiments, the field device manager 230 presents a graphical user interface (GUI) (e.g., via the user interface 216) for giving a user insight into the commissioning procedures of the field device manager 230. Such a GUI may provide an interface for selecting or otherwise defining testing procedures to be performed, a button or other selector for allowing a user to instruct the field device manager 230 to begin a commissioning process, an interface showing the status of an ongoing commissioning process, or a report of a completed commissioning process along with identification of which field devices 296 passed or failed commissioning, recommendations for fixing failures, or other useful statistics.

In some embodiments, the data generated by a commissioning process may be useful to further train the digital twin 220. For example, if activating a heating radiator does not cool a room as much as expected, there may be a draft or open window in the room that was not originally accounted for that can now be trained intro the digital twin 220 for improved performance. As such, in some embodiments, the field device manager 230 may log the commissioning data in a form useful for the learning engine 268 to train the digital twin 220, as will be explained in greater detail below.

In some embodiments, the field device manager 230 may also play a role in networking. For example, the field device manager 230 may monitor the health of the network formed between the controller 210 and the additional controllers 292 by, for example, periodically initiating test packets to be sent among the additional controllers 292 and reported back, thereby identifying when one or more additional controllers 292 are no longer reachable due to, e.g., a device malfunction, a device being turned off, or a network link going down. In a case where one of the additional controllers 292 had been elected leader, the field device manager 230 may call for a new leader election among the remaining reachable additional controllers 292 and then proceed to participate in the election according to any of various possible techniques.

With respect to runtime control of the field devices 296, while other components (such as the control pathfinder 264) may decide what control actions are to be taken and make them available to other components (e.g., by writing the desired actions to the database 226), the field device manager 230 may be responsible for issuing the commands to the field devices 296 that cause the desired action to occur. In some embodiments, where the controller 210 is elected leader controller, the field device manager 230 may issue commands not only to the field devices 296 connected to the controller 210 but also to the additional controllers 292. In other embodiments where the database 226 is available to multiple controllers 210, 292 (e.g., through database replication techniques, by allowing the additional controllers 292 to query the database 226 of the controller 210, or by making the database 226 available on a different accessible server) the respective field device managers 230 or analogous components of the additional controllers 292 may similarly notice updates to the desired control actions and issue commands to their respective attached field devices 296 to effect the desired controls. Various additional techniques for implementing a field device manager 230 according to various embodiments may be described in U.S. Pat. Nos. 11,477,905; 11,596,079; and U.S. patent application publication numbers 2022/0067226; 2022/0067227; 2022/0067230; and 2022/0070293, the entire disclosures of which are hereby incorporated herein by reference.

Various embodiments utilize a higher order language to direct operations internal to the controller 210 and additional controllers 292. As an example, while field devices 296 may be controlled or otherwise communicate according to various diverse semantics and protocols (e.g., BACnet, Modbus, Wirepas, Pulse-Width Modulation, Frequency Modulation, 1-Wire, Bluetooth Low Energy Mesh, Ethernet, WiFi, 24 VAC, Voltage signal, Current signal, Resistance signal, the higher order language itself, etc.), desired actions identified by the control pathfinder 264, written to the database 226, or issued by the field device manager 230 may be agnostic to these particular differences. As another example, while the actions that the field devices 296 can perform may be differentiated based on the characteristics of a device (a pump can be instructed to pump fluid, a fan can be instructed to spin), these actions may be abstracted (or semantically raised) into the same action (either of these devices may be instructed to cause quanta to move). Thus, when a BACnet pump is to be instructed to begin pumping fluid, rather than issuing a specific BACNet command that will activate that pump or issuing an instruction for the pump to begin pumping, the field device manager 230 may issue a command that the particular “transport” field device 296 begin to move quanta from its input to its output. Such a higher order language may be reflective of the high order at which the digital twin 220 is defined, as will be explained in greater detail below.

While some field devices 296 may natively understand the higher order language, others may still require communication according to their own native protocols. A semantic translator 232 may thus be responsible for translating higher order language communications received from the field device manager 230 or distributed work engine 240 into the appropriate lower level, protocol specific messages that will be sent via the communication interface 212. So, where the field device manager 230 issues a command for a particular transport field device 296 to begin moving quanta, the semantic translator 232 may semantically lower this command to a command for a pump to begin pumping fluid (or for a fan to begin spinning, etc., depending on the specifics of the device as may be defined in the digital twin 220) and then semantically translate this command to a BACnet message (or Modbus, etc., depending on the specifics of the device as may be defined in the digital twin 220) that will accomplish the lowered action. The semantic translator 232 may then transmit the fully-formed message to the appropriate recipient device via the communications interface 212. Thus, while the digital twin 220 and other internal components of the controller 210, may operate according to a semantically-raised language (which may be driven by a semantic ontology used in the digital twin 220), the digital twin 220 may additionally store information for the various field devices 296 useful in semantically lowering and translating this language to enable effective communication with the field devices 296. In various embodiments, the semantic translator 232 may work in the opposite direction as well, translating and raising incoming messages from the field devices 296, such that they may be interpreted and acted on according to the semantically raised language of the controller 210. Various techniques for implementing a semantic translator 232, a digital twin 220 ontology, or an internal semantically-raised language according to some embodiments may be disclosed in U.S. patent application publication numbers 2022/0066754; and 2022/0066761, the entire disclosures of which are incorporated herein by reference.

As shown, the controller 210 includes a distributed work engine 240 for guiding the distributed operation of the controller 210 with additional controllers 292. As such, the distributed work engine 240 may receive computation steps (e.g., from the solver engine 250) to be outsourced to other controllers 292, transmit the work (via the semantic translator 232 or communication interface 292) to the additional controllers 292, receive work results back, and pass them back to the solver engine 250. Such a workflow may be used when, for example, the controller 210 has been elected as a leader controller. The distributed work engine 240 may also implement the other side by receiving work requests from one or more additional controllers 292, passing the work requests to the solver engine 250 or directly to a step engine 260, receiving the result of the work, and transmitting the result back to the requesting controller 292. Such a workflow may be used when, for example, the controller 210 has been not elected as a leader controller and is, instead, a follower controller. In various alternative embodiments, the controller 210 may both issue work requests to other controllers 292 and execute work requests received from additional controllers 292, regardless of status as a leader or follower (if any). The distributed work engine 240 may perform additional functionality associated with managing a distributed compute system such as, for example, selecting particular ones of the additional controllers 292 to receive particular work requests, receiving load metrics or otherwise assessing compute health/capacity of the additional controllers 292, performing load balancing among the additional controllers 292, and deciding when to resend or reassign previously issued work requests, and when to time out previously issued work requests (too much time has elapsed, a sufficient number of other responses have been received, etc.) and instruct the solver engine 250 to move on with the next steps of a computation. Various additional techniques for implementing a distributed work engine 240 according to some embodiments may be described in U.S. Pat. No. 11,490,537, the entire disclosure of which is hereby incorporated herein by reference.

A solver engine 250 may be responsible for driving many, if not all, of the higher order functions of the controller 210 such as, for example, running simulations, deciding on control actions to be taken, causing the digital twin 220 to learn from observations, etc. To effect such actions, the solver engine 250 may execute various recipes 252 (which may be stored in the database 226 or elsewhere) that define a sequence of steps to be performed by separate step engines 260. Accordingly, the solver engine 250 may identify a recipe to be executed (e.g., based on manual selection of a recipe 252 for execution by a user, invocation of a recipe 252 by step engine 260, identification by the step of another recipe 252 under execution, a scheduled time for a recipe 252, a timer elapsing since the past execution of the recipe 252, or the occurrence of some trigger event associated with the recipe 252). The solver engine 250 may then begin to “walk through” the steps of the recipe 252, identifying an appropriate step engine 260 to perform the step, issuing the step to that step engine 260, receiving the result after the step engine 260 has completed its work, and then move on to the next step of the recipe 252. In some embodiments, the solver engine 250 may itself be adapted to perform some steps. The solver engine 250 may then iterate on this process until it reaches the end of the recipe 252.

In some cases, the solver engine 250 may decide that one or more steps of a recipe 252 are to be outsourced to another controller 292. For example, the recipe 252 itself may specify that a step is to be performed by another controller 292, the solver engine 250 may determine that local processing capacity is not sufficient to perform a step, or the solver engine may encounter multiple parallel steps in a recipe 252 and decide to perform only one or a subset locally while outsourcing the rest.

The step engines 260 may include a number of varying functions that can be relied on by the recipes 252 and solver engine 250 to perform various steps of a larger task. As shown, the step engines 260 include a simulator 262, a control pathfinder 264, and inference kit 266, a learning engine 268, and one or more additional step engines 270. It will be apparent that fewer, additional, or different step engines 270 may be included depending on the functions to be performed by the controller 210 (e.g., as may be defined in the recipes 252) and as appropriate to adapting the controller 210 for use in different applications.

The simulator 262 may be configured to simulate the behavior of the system 100 into the future or under alternative/hypothesis conditions. To accomplish such a simulation, the simulator 262 may execute a sequence of time steps (e.g., simulating the state of the digital twin 220 a minute into the future at a time) until the future time is reached and state can be read from the digital twin 220. For example, to simulate the temperature of a zone one hour into the future, the simulator 262 may propagate heat from all heat sources through the digital twin 220 one minute at a time, sixty times, and then read the temperature of the zone from the digital twin 220. The use of the digital twin 220 to perform such simulations will be explained in greater detail below. In various embodiments, the simulator 262 may actually encompass multiple more specific simulator step engines. For example, the simulator 262 may include separate simulators for simulating state of the building, operating of equipment, occupancy of different zones of the building, and the impact of weather or other external factors on the state of the system 100. The simulator 262 (or other step engines 260) may make use of the digital twin in different manners. In some cases, the simulator 262 may retrieve a precompiled (e.g., at the time of initial digital twin creation) digital twin 220, place it in memory, populate relevant data into it, and use the data that is produced as simulation output. In other cases, the simulator 262 may alter portions of the digital twin 220 description at the time of simulation (e.g., adding or removing equipment, or changing equipment parameters), compile the digital twin at that point in time, place the newly-compiled twin in memory, and then run its simulation. Thus, the digital twin 220 may include both a data description of the systems being modeled as well as compiled and functional versions of that data description.

The control pathfinder 264 may be configured to identify, using the digital twin 220, one or more control actions to be performed be the field devices 296 to reach a desired state. For example, the control pathfinder 264 may analyze multiple possible candidate control schemes against the digital twin 220 to determine which candidate control scheme best produces the desired state in the digital twin 220 and then write the control actions from that scheme to the database 226 for the field device manager 230 to act on. In some embodiments, the control pathfinder 264 may leverage the simulator 262 to perform its task (and likewise, step engines 260 may in some embodiments generally invoke each other when useful to the performance of their task).

In other embodiments, the control pathfinder 264 may utilize auto-differentiation and gradient descent to identify an appropriate control scheme to reach a desired state in the digital twin 220. As will be explained in greater detail below, through auto-differentiation, the digital twin 220 may be established as omnidirectional; that is, while activation functions may be defined or learned in a forward direction, their partial derivatives may be used to define “activation functions” in the reverse direction, thereby enabling traversal of the digital twin 220 in any direction and along any path desired. When paired with differentiable programming to define the digital twin 220 (particularly, its activation functions), such partial derivatives may be made available in the digital twin 220 with little-to-no additional compute cost. From here, the control pathfinder 264 may generate a cost function on the digital twin 220 that relates a set of input variables (e.g., possible control variables) to a cost—the distance between the predicted state values and the desired state values. The control pathfinder 264 may then employ gradient descent to identify a control scheme likely to produce the desired state in the environment 110 (or a state acceptably close to the desired state).

Various additional, alternative, or modified methods may be used by the control pathfinder 264 to locate a control path. For example, in some embodiments, the control pathfinder 264 may employ multiple gradient descent agents (e.g., as a Self-Organizing Migrating Algorithm or SOMA) to improve the likelihood of locating a global minimum of the cost function, rather than a local minimum representing a sub-optimal solution control scheme. In some embodiments, a simpler neural network trained against the digital twin 220 for a reduced problem may be used by the control pathfinder 264 to find a control scheme quickly which is then tested and refined against the digital twin 220 or written directly to the database so that the field devices 296 may be controlled immediately. In some embodiments, the control pathfinder 264 may employ more than one of these and other approaches in an ensemble or adversarial approach to find optimal control schemes. Various additional techniques that may be used in implementing a simulator 262, control pathfinder 264, other step engines 260, or other aspects of the controller 210 according to some embodiments may be described in U.S. Pat. Nos. 10,705,492; 10,921,760; U.S. patent application publication numbers 2021/0381712; 2021/0382445; 2021/0383042; and 2021/0383219, the entire disclosures of which are hereby incorporated herein by reference.

The inference kit 266 may be configured to draw information from the digital twin 220 for use in driving decisions. As such, the inference kit 266 may enable reading of values from the digital twin 220 and transformation of such values into derived properties and other values (e.g., reading heat and humidity values and sending them through a transformation to produce a comfort value). In various embodiments, the inference kit 266 may provide more advanced inferencing such as performing sensor fusion and defining “virtual sensors” to enable simulation of additional state values at locations where there are not sensors in the real world system 100 from which to draw information. Various techniques for implementing an inference kit 266 according to some embodiments may be disclosed in U.S. patent application publication number 2021/0383236, the entire disclosure of which is hereby incorporated herein by reference.

The learning engine 268 may be configured to train machine learning models for the benefit of the controller 210. For example, in various embodiments, the digital twin 220 itself is trainable. As such, the learning engine 268 may periodically use one or more training examples and machine learning approaches (such as supervised learning and gradient descent) to train the digital twin's 220 activation functions to better model the observed real world system. Such training examples may be drawn from the database 226 (e.g., from sensor data placed there by the field device manager 230 or additional controllers 292). In some embodiments, the learning engine 268 may train additional neural networks, deep learning networks, or other machine learning models based on the simulations (e.g., as may be run by the simulator 262). As such, the learning engine 268 may include a training archivist that captures simulated cases during execution of a recipe 252 and stores them as training examples in the database 226. The learning engine 268 may later used these training examples to train these simple models for later use. Thus, in various embodiments, the learning engine 268 trains the digital twin 220 based on real world observed data and then trains simple models based on the operation of the digital twin 220. Various additional techniques for implementing a learning engine 268 according to some embodiments may be disclosed in U.S. patent application publication number 2021/0383041, the entire disclosure of which is hereby incorporated by reference herein.

As noted, the step engines 260 may include additional step engines 270 as appropriate to the recipes 252 and application of the controller 210. For example, the additional step engines 270 may include an ontological reasoner (which may use various techniques to simplify the digital twin 220 to only those portions relevant to a particular task, thereby reducing processing resources needed), an occupant process (which may take into account occupant comfort needs or desires to guide the determination of a desired state in a system), a weather process (which may make or otherwise obtain weather forecasts), and other engines. Various additional step engines 270 that may be useful will be apparent. Various additional techniques for implementing such additional step engines 270 according to some embodiments may be described in in U.S. Pat. Nos. 10,969,133; and 11,553,618, the entire disclosures of which are hereby incorporated herein by reference.

It will be apparent that, while particular components are shown connected to one another, this may be a simplification in some regards. For example, components that are not shown as connected may nonetheless interact. For example, the user interface 216 may provide a user with some access to the recipes 252 or field device manage 230. Furthermore, in various embodiments, additional components may be included and some illustrated components may be omitted. In various embodiments, various components may be implemented in hardware, software, or a combination thereof. For example, the communications interface 212 may be a combination of communications protocol software, wired terminals, a radio transmitter/receiver, and other electronics supporting the functions thereof. As another example, the solver engine 250 and step engines 260 may be implemented as software running on a processor (not shown) of the controller 210, while the digital twin 220 may be a data structure stored in the database 226 which, in turn, may include memory chips and software for managing database organization and access. Various other implementation details will be apparent and various techniques for implementing a controller 210 and various components thereof according to some embodiments may be described in U.S. patent application publication numbers 2022/0066432; 2022/0066722; U.S. provisional patent applications 62/518,497; 62/704,976; and 63/070,460 the entire disclosures of which are hereby incorporated herein by reference.

It will be further apparent that various techniques described herein may be utilized in contexts outside of controller devices. For example, various techniques may be adapted to project planning tools, report generation, reporting dashboards, simulation software, modeling software, computer aided drafting (CAD) tools, predictive maintenance, performance optimization tools, or other applications. Various modifications for adaptation of such techniques to other applications and domains will be apparent.

FIG. 3 illustrates an example digital twin 300 for use in various embodiments. The digital twin 300 may correspond, for example, to the digital twin 220, the environment twin 222, or the controlled system twin 224 of FIG. 2. As shown, the digital twin 300 includes a number of nodes 310, 311, 313, 314, 316, 317, 320, 322, connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310, 311, 313, 314, 316, 317, 320, 322, may correspond, for example, to aspects of the environment 110 such as HVAC zones, walls, windows, external forces (such as weather); aspects of the sensor system 130 such as individual sensors; aspects of the controllable system 120 such as controllable HVAC equipment; virtual entities, such as HVAC zone subdivisions or virtual sensors that may be assigned values through sensor fusion; or other aspects that may be used in a simulation. The edges between the nodes 310, 311, 313, 314, 316, 317, 320, 322, may, then, represent some relationship between the system aspects represented by the nodes 310, 311, 313, 314, 316, 317, 320, 322; an edge may represent, for example, physical proximity or relative location, proximity or relative location within a control loop of a system, or another relationship.

FIG. 3 illustrates an example digital twin 300 for construction by or use in various embodiments. The digital twin 300 may correspond, for example, to digital twin 120 or digital twin 210. As shown, the digital twin 300 includes a number of nodes 310, 311, 313, 314, 316, 317, 320, 322 connected to each other via edges. As such, the digital twin 300 may be arranged as a graph, such as a neural network. In various alternative embodiments, other arrangements may be used. Further, while the digital twin 300 may reside in storage as a graph type data structure, it will be understood that various alternative data structures may be used for the storage of a digital twin 300 as described herein. The nodes 310-323 may correspond to various aspects of a building structure such as zones, walls, and doors. The edges between the nodes 310-323 may, then, represent relationships between the aspects represented by the nodes 310-323 such as, for example, adjacency for the purposes of heat transfer.

As shown, the digital twin 300 includes two nodes 310, 320 representing zones. A first zone node 310 is connected to four exterior wall nodes 311, 312, 313, 315; two door nodes 314, 316; and an interior wall node 317. A second zone node 320 is connected to three exterior wall nodes 321, 322, 323; a door node 316; and an interior wall node 317. The interior wall node 317 and door node 316 are connected to both zone nodes 310, 320, indicating that the corresponding structures divide the two zones. This digital twin 300 may thus correspond to a two-room structure.

It will be apparent that the example digital twin 300 may be, in some respects, a simplification. For example, the digital twin 300 may include additional nodes representing other aspects such as additional zones, windows, ceilings, foundations, roofs, or external forces such as the weather or a forecast thereof. It will also be apparent that in various embodiments the digital twin 300 may encompass alternative or additional systems such as controllable systems of equipment (e.g., HVAC systems).

According to various embodiments, the digital twin 300 is a heterogenous neural network. Typical neural networks are formed of multiple layers of neurons interconnected to each other, each starting with the same activation function. Through training, each neuron's activation function is weighted with learned coefficients such that, in concert, the neurons cooperate to perform a function. The example digital twin 300, on the other hand, may include a set of activation functions (shown as solid arrows) that are, even before any training or learning, differentiated from each other, i.e., heterogenous. In various embodiments, the activation functions may be assigned to the nodes 310-323 based on domain knowledge related to the system being modeled. For example, the activation functions may include appropriate heat transfer functions for simulating the propagation of heat through a physical environment (such as function describing the radiation of heat from or through a wall of particular material and dimensions to a zone of particular dimensions). As another example, activation functions may include functions for modeling the operation of an HVAC system at a mathematical level (e.g., modeling the flow of fluid through a hydronic heating system and the fluid's gathering and subsequent dissipation of heat energy). Such functions may be referred to as “behaviors” assigned to the nodes 310-323. In some embodiments, each of the activation functions may in fact include multiple separate functions; such an implementation may be useful when more than one aspect of a system may be modeled from node-to-node. For example, each of the activation functions may include a first activation function for modeling heat propagation and a second activation function for modeling humidity propagation. In some embodiments, these diverse activation functions along a single edge may be defined in opposite directions. For example, a heat propagation function may be defined from node 310 to node 311, while a humidity propagation function may be defined from node 311 to node 310. In some embodiments, the diversity of activation functions may differ from edge to edge. For example, one activation function may include only a heat propagation function, another activation function may include only a humidity propagation function, and yet another activation function may include both a heat propagation function and a humidity propagation function.

According to various embodiments, the digital twin 300 is an omnidirectional neural network. Typical neural networks are unidirectional-they include an input layer of neurons that activate one or more hidden layers of neurons, which then activate an output layer of neurons. In use, typical neural networks use a feed-forward algorithm where information only flows from input to output, and not in any other direction. Even in deep neural networks, where other paths including cycles may be used (as in a recurrent neural network), the paths through the neural network are defined and limited. The example digital twin 300, on the other hand, may include activation functions along both directions of each edge: the previously discussed “forward” activation functions (shown as solid arrows) as well as a set of “backward” activation functions (shown as dashed arrows).

In some embodiments, at least some of the backward activation functions may be defined in the same way as described for the forward activation functions-based on domain knowledge. For example, while physics-based functions can be used to model heat transfer from a surface (e.g., a wall) to a fluid volume (e.g., an HVAC zone), similar physics-based functions may be used to model heat transfer from the fluid volume to the surface. In some embodiments, some or all of the backward activation functions are derived using automatic differentiation techniques. Specifically, according to some embodiments, reverse mode automatic differentiation is used to compute the partial derivative of a forward activation function in the reverse direction. This partial derivative may then be used to traverse the graph in the opposite direction of that forward activation function. Thus, for example, while the forward activation function from node 311 to node 310 may be defined based on domain knowledge and allow traversal (e.g., state propagation as part of a simulation) from node 311 to node 310 in linear space, the reverse activation function may be defined as a partial derivative computed from that forward activation function and may allow traversal from node 310 to 311 in the derivative space. In this manner, traversal from any one node to any other node is enabled—for example, the graph may be traversed (e.g. state may be propagated) from node 312 to node 313, first through a forward activation function, through node 310, then through a backward activation function. By forming the digital twin as an omnidirectional neural network, its utility is greatly expanded; rather than being tuned for one particular task, it can be traversed in any direction to simulate different system behaviors of interest and may be “asked” many different questions.

According to various embodiments, the digital twin is an ontologically labeled neural network. In typical neural networks, individual neurons do not represent anything in particular; they simply form the mathematical sequence of functions that will be used (after training) to answer a particular question. Further, while in deep neural networks, neurons are grouped together to provide higher functionality (e.g. recurrent neural networks and convolutional neural networks), these groupings do not represent anything other than the specific functions they perform; i.e., they remain simply a sequence of operations to be performed.

The example digital twin 300, on the other hand, may ascribe meaning to each of the nodes 310-323 and edges therebetween by way of an ontology. For example, the ontology may define each of the concepts relevant to a particular system being modeled by the digital twin 300 such that each node or connection can be labeled according to its meaning, purpose, or role in the system. In some embodiments, the ontology may be specific to the application (e.g., including specific entries for each of the various HVAC equipment, sensors, and building structures to be modeled), while in others, the ontology may be generalized in some respects. For example, rather than defining specific equipment, the ontology may define generalized “actors” (e.g., the ontology may define producer, consumer, transformer, and other actors for ascribing to nodes) that operate on “quanta” (e.g., the ontology may define fluid, thermal, mechanical, and other quanta for propagation through the model) passing through the system. Additional aspects of the ontology may allow for definition of behaviors and properties for the actors and quanta that serve to account for the relevant specifics of the object or entity being modeled. For example, through the assignment of behaviors and properties, the functional difference between one “transport” actor and another “transport” actor can be captured.

The above techniques, alone or in combination, may enable a fully-featured and robust digital twin 300, suitable for many purposes including system simulation and control path finding. The digital twin 300 may be computable and trainable like a neural network, queryable like a database, introspectable like a semantic graph, and callable like an API.

As described above, the digital twin 300 may be traversed in any direction by application of activation functions along each edge. Thus, just like a typical feedforward neural network, information can be propagated from input node(s) to output node(s). The difference is that the input and output nodes may be specifically selected on the digital twin 300 based on the question being asked, and may differ from question to question. In some embodiments, the computation may occur iteratively over a sequence of timesteps to simulate over a period of time. For example, the digital twin 300 and activation functions may be set at a particular timestep (e.g., 1 minute), such that each propagation of state simulates the changes that occur over that period of time. Thus, to simulate longer period of time or point in time further in the future (e.g., one minute), the same computation may be performed until a number of timesteps equaling the period of time have been simulated (e.g., 60 one second time steps to simulate a full minute). The relevant state over time may be captured after each iteration to produce a value curve (e.g., the predicted temperature curve at node 310 over the course of a minute) or a single value may be read after the iteration is complete (e.g., the predicted temperature at node 310 after a minute has passed). The digital twin 300 may also be inferenceable by, for example, attaching additional nodes at particular locations such that they obtain information during computation that can then be read as output (or as an intermediate value as described below).

While the forward activation functions may be initially set based on domain knowledge, in some embodiments training data along with a training algorithm may be used to further tune the forward activation functions or the backward activation functions to better model the real world systems represented (e.g., to account for unanticipated deviations from the plans such as gaps in venting or variance in equipment efficiency) or adapt to changes in the real world system over time (e.g., to account for equipment degradation, replacement of equipment, remodeling, opening a window, etc.).

Training may occur before active deployment of the digital twin 300 (e.g., in a lab setting based on a generic training data set) or as a learning process when the digital twin 300 has been deployed for the system it will model. To create training data for active-deployment learning, a controller device (not shown) may observe the data made available from the real-world system being modeled (e.g., as may be provided by a sensor system deployed in the environment 110) and log this information as a ground truth for use in training examples. To train the digital twin 300, that controller may use any of various optimization or supervised learning techniques, such as a gradient descent algorithm that tunes coefficients associated with the forward activation functions or the backward activation functions. The training may occur from time to time, on a scheduled basis, after gathering of a set of new training data of a particular size, in response to determining that one or more nodes or the entire system is not performing adequately (e.g., an error associated with one or more nodes 310-323 passed a threshold or passes that threshold for a particular duration of time), in response to manual request from a user, or based on any other trigger. In this way, the digital twin 300 may be adapted to better adapt its operation to the real world operation of the systems it models, both initially and over the lifetime of its deployment, by tacking itself to the observed operation of those systems.

The digital twin 300 may be introspectable. That is, the state, behaviors, and properties of the 310-323 may be read by another program or a user. This functionality is facilitated by association of each node 310-323 to an aspect of the system being modeled. Unlike typical neural networks where, due to the fact that neurons don't represent anything particularly the internal values are largely meaningless (or perhaps exceedingly difficult or impossible to ascribe human meaning), the internal values of the nodes 310-323 can easily be interpreted. If an internal “temperature” property is read from node 310, it can be interpreted as the anticipated temperature of the system aspect associated with that node 310.

Through attachment of a semantic ontology, as described above, the introspectability can be extended to make the digital twin 300 queryable. That is, ontology can be used as a query language usable to specify what information is desired to be read from the digital twin 300. For example, a query may be constructed to “read all temperatures from zones having a volume larger than 200 square feet and an occupancy of at least 1.” A process for querying the digital twin 300 may then be able to locate all nodes 310-323 representing zones that have properties matching the volume and occupancy criteria, and then read out the temperature properties of each. The digital twin 300 may then additionally be callable like an API through such processes. With the ability to query and inference, canned transactions can be generated and made available to other processes that aren't designed to be familiar with the inner workings of the digital twin 300. For example, an “average zone temperature” API function could be defined and made available for other elements of the controller or even external devices to make use of. In some embodiments, further transformation of the data could be baked into such canned functions. For example, in some embodiments, the digital twin 300 itself may not itself keep track of a “comfort” value, which may defined using various approaches such as the Fanger thermal comfort model. Instead, e.g., a “zone comfort” API function may be defined that extracts the relevant properties (such as temperature and humidity) from a specified zone node, computes the comfort according to the desired equation, and provides the response to the calling process or entity.

It will be appreciated that the digital twin 300 is merely an example of a possible embodiment and that many variations may be employed. In some embodiments, the number and arrangements of the nodes 310-323 and edges therebetween may be different, either based on the device implementation or based on the system being modeled. For example, a controller deployed in one building may have a digital twin 300 organized one way to reflect that building and its systems while a controller deployed in a different building may have a digital twin 300 organized in an entirely different way because the building and its systems are different from the first building and therefore dictate a different model. Further, various embodiments of the techniques described herein may use alternative types of digital twins. For example, in some embodiments, the digital twin 300 may not be organized as a neural network and may, instead, be arranged as another type of model for one or more components of the environment 110. In some such embodiments, the digital twin 300 may be a database or other data structure that simply stores descriptions of the system aspects, environmental features, or devices being modeled, such that other software has access to data representative of the real world objects and entities, or their respective arrangements, as the software performs its functions.

Distributed networks, such as the distributed network 130 discussed above, may be inadvertently segregated. During inadvertent segregation, parts of the network may be unintentionally isolated from each other. This unintended segregation by result from various issues. Some of these issues include misconfigured firewalls or access control lists, routing issues, physical devices being connected to the wrong network, hardware issues, network maintenance errors, network faults, etc. Resolving inadvertent network segregation may involve time-consuming, careful analysis without a digital twin. With a digital twin, 220, 300. In the event of a network failure segregating the network into two or more subnetworks, each segregated portion may elect its own leader controller to continue control for areas that the leader controller can reach. The digital twin 220, 300 may allow each leader to simulate the portions of the system that it can control and provide direction to those portions until the network is healed.

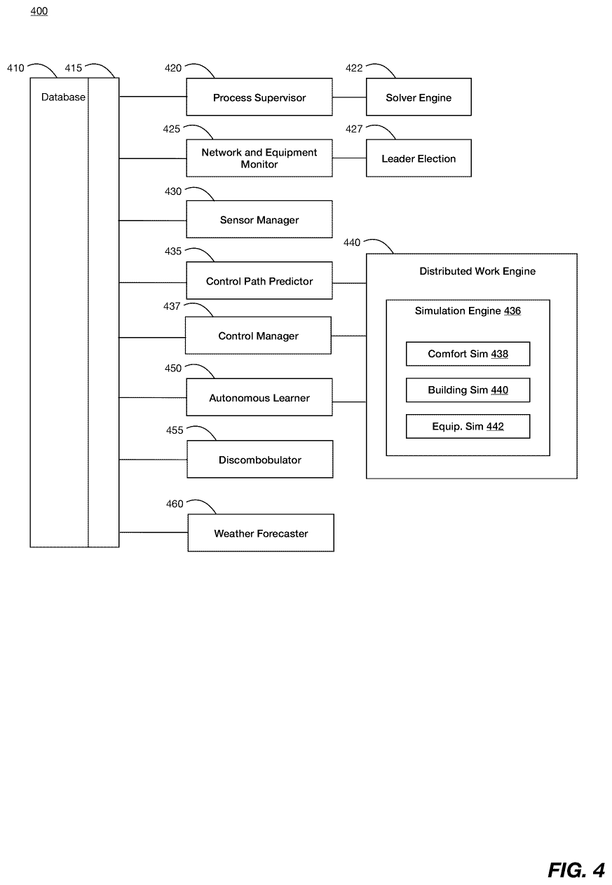

FIG. 4 illustrates an example controller system or portion of a system 400 for construction by or use in various embodiments. The controller system 400 may correspond, for example, to an alternative embodiment of a portion of the controller system 200. For example, the example controller system 400 may replace all or part of step engine 260, solver engine 250, all or a portion of the digital twin 220, or a different section. This example controller system may function within a system partition, where the functions of the controller system are for a portion of the controllable system that the partition can control. This allows separately controllable systems to act independently while optimizing for the current state of the entire system. That the entire database necessary for such functions for the digital twin is stored locally on the controllers that may be elected leaders allows such optimization to take place. There may also be controllers, such satellite controllers, that do not have full functionality and so both cannot be made leaders and do not store the whole necessary database.

The database 410 may store information for use by the rest of the system. This information may be in the form of a data schema, which may define the structure of digital twin information, controller information, device information, sensor information, network and equipment monitoring information etc. A database registry 415 may be used to ensure data consistency, standardization, and understanding of data across the system. It may have metadata, information about data elements, etc.

A process supervisor (or “watchdog”) may be used to detect errors, such as those that may result in a network error. As such, it may be able to start and stop other processes, e.g. 420, 425, 430, 435, 450, 455, 460. More generally, the Process Supervisor may be the supervisory process of the other control processes. One of its jobs is to evaluate the performance of each process individually, and all processes collectively, to determine if the system is operating correctly. As long as the system is performing correctly, system metrics and valuable debug information may be gathered by it or an associated process. These metrics include things such as error or warning logs and process performance (used memory, CPU time, etc.). When a child process stops communicating, or sends an error message, the Process Supervisor follows a procedure for resetting the process or the entire system if necessary, which may include setting up and running a divided network. At times, full-system reboots may be necessary, but are reserved for only those situations that cannot be mitigated with a partial or subsystem reset. Due to the information stored within the digital twin and elsewhere, systems may often be partially down and still run.

The process supervisor 420 may control the solver engine 422. This solver engine 422 may be equivalent to the FIG. 2 solver engine 250. The control path predictor 435, control manager 437, and autonomous learner 450 may also, at times, control the solver engine, or may communicate with the process supervisor to communicate with the solver engine 422. In some embodiments, the solver engine is controlled by other processes.

In some embodiments, the network and equipment monitor 425 wakes up devices and makes them discoverable by one another. It then compares what is found onsite to what the database 226, 410, the digital twin 220, or another repository said should be there and flags discrepancies. At this point, devices (e.g., 292, 294, 296) are ready to connect to each other. The Network Monitor may be used to establish wired communication paths between devices and initializes setup of wireless mesh networks. This process is known as “self-federation.” With networks up and running, the monitor 425 establishes a lead controller for the network. This may be done by the Network and Equipment Monitor 425 or by leader election 427 among the controllers themselves. This leader controller is responsible for aggregating the compute resources of all devices, coordinating and distributing control decisions, and acting as a bridge to any external networks. If the leader controller goes down, the Network and Equipment Monitor may choose a new leader to continue operation without loss of data. Other controllers may have a complete copy of portions of the system, such as a copy of the digital twin, though physical equipment connections to that broken controller could be lost. If part of the network experiences loss of connection, the Network and Equipment Monitor 425 will attempt to reroute to a viable path. For example, if a controller loses power and can no longer act as a node in the wireless network, the monitor 425 will establish a new mesh network to send information through other devices. If the Network and Equipment Monitor 425 can't establish a viable reroute, an error may be sent to the Process Supervisor 420 for evaluation. Mesh networks may be used. The mesh networks may be flexible entities that can adapt over time to meet the communication needs of the system of devices. The Network and Equipment Monitor 425 looks after the connectivity of devices and ensures information is flowing as needed. This includes connectivity from equipment and sensors (PassiveLogic and third-party sensors) to the controllers 200, 292, 400.

As mentioned, the Network and Equipment Monitor 425 elects a lead controller for the network. This leader may be used as a gatekeeper between the devices in the building and any relevant external cloud databases. When information is brought in from the cloud, the leader disseminates it throughout the network of followers. Followers maintain their own copy of the data locally, e.g., the database 410 or elsewhere, which provides redundancy across the network. Cloud connection is not mandatory, and as such, controllers 200, 292, 400 can maintain their data locally. The network may be completely separate from other existing networks, including the internet. In some embodiments, the only path for data to move in and out through the network via a bridge. This bridge may be maintained by the lead hive controller, or by someone else.

The sensor manager identifies and polls sensor devices to keep track of which sensors are on-line, to update current state info, and so on. The Sensor Manager 430 may be woken up by the Process Supervisor 420, at a certain time, when an event happens, etc. When sensor manager 430 wakes up it may retrieve a list of sensor devices (e.g., 296) from the digital twin 220 or elsewhere, such as a database 226, 410 where it is stored. It then connects with other sensors to initiate polling of the current state, or sensed value, of the devices. The Sensor Manager 430 takes that information and updates a database, e.g., 226, 410 with the new data. This process may be continuous, keeping the database updated regularly, or may occur on a schedule, when events occur, when instructed, and so on. In some embodiments, the Sensor Manager 430 maintains a schedule of how frequently to poll the sensor network-some sensors get updated more frequently than others depending on the need for the most current value and power requirements for transmitting data. The Sensor Manager 430 may also receive asynchronous events from devices that do not support polling and chooses when to send updates. The Sensor Manager 430 may also detect when sensed values are off from expected values over time. Very noisy data, anomalous or unusually rapid value changes, no value change for an extended period of time, and out-of-bounds values may have the Sensor Manager 430 raising a red flag. This red flag may be communicated to the Process Supervisor 420. This may be contextualized by a building simulator 436, 440 (e.g., is it possible that temperature in a space really did shoot up 10° F. in two seconds, or is the sensor hardware failing to read correctly?).

The control pathfinder may include a control path predictor 435, a control manager 437, and an autonomous learner 450. These may interact with the distributed work engine 440, which may hold the simulation engine. The distributed work engine may run during a network partition within a partition to control the parts of the controllable system that are within reach of the controllers within a given partition. The control path predictor 435 may select better control paths from a large number of potential control paths. These better control paths may be then stored in the appropriate database 410. When a system is partitioned, the control path predictor may select control paths for the portion of the controllable space that the partition has control of. In some instances, the control paths chosen and stored may be the optimal control paths found. The control manager 437 may read the current control path that has been chosen from a database 410 or elsewhere. Similarly, the control manager will work within a partition.

The Autonomous Learner 450 may bridge the gap between what a building thinks and what it observes. It analyzes data from sources like sensors and weather services. Differences between data and simulated results provide the necessary feedback to refine the building's understanding of itself and its environment. Aspects of this learning process may include one or more of different aspects, some of which are described below. Models may be optimized by identifying stochastic events. Simulation accuracy degrades further into the future that is simulated. This process measures how quickly accuracy degrades with the length of the simulation horizon. The Control Process uses this to know the maximum simulation time horizon before models become too inaccurate to trust. It picks an accuracy threshold, say 95%, to determine the maximum time horizon. Models may be optimized by tuning parameters. To improve model accuracy, the model parameters are tuned to better estimate the future. This is like the rules of how pieces move in chess, such as how a bishop can move only diagonally. Stochastic events may be identified. Historical patterns may be identified that aren't being explicitly modeled to account for some discrepancies between simulation and observation. Examples may include operational statistics (e.g., when the building is occupied), internal loads (e.g., a server farm), or local climate biases (e.g., more humidity than the rest of the zip code). Faults may be detected. Given a history of model parameters over the life of an install site, a sudden significant change in model parameters could be an indication of some kind of equipment or building fault. The control process may be evaluated. The Control Process will begin with a particular approach to determine the best control path. But it will also evaluate how other approaches could compete with the current approach and might be better. The Control Process will move to an alternate approach when it consistently results in better control. For example, it may employ a different path or tune some hyper parameters. Specific data may be evaluated. Executing a particular control path may provide more information about the quality of models or control approach than the typical control paths used in daily operations (e.g., turning off all equipment except one subsystem). This would be done at a time of day that wouldn't interfere with regular operations. In other words, one can take a more experimental approach that might be run during unoccupied times to expand the scope of knowledge that couldn't be gained by “business as usual” in the building.

Autonomous Learning 450 is the process that tunes digital twin models to be as close to reality as possible. It observes differences between the model and actual system behaviors and updates the digital twin with more accurate information. Since behaviors change over time, Autonomous Learning 450 is always a relevant process for keeping the digital twin model up to date. Autonomous Learning is also not an essential process for controlling a building—the process is run to hone the accuracy of the models. It is computationally expensive, which means one must prioritize how often to do it and schedule correctly when compute resources are available. This time could be at night when building conditions aren't changing rapidly and other control processes are less busy. Finally, Autonomous Learning 450 may be responsible for adjusting how often the Control Path Predictor 435 runs. When the predictor finds large differences between the model and reality, it might decide to run more often. When behaviors are similar and things are tracking as expected, the Control Path Predictor may run less frequently.

“Discombobulate” means to take apart things that are already combined. The Discombobulator 455 takes the entire system of equipment for the building and figures out all the subsystems that exist therein. Breaking the mechanical system into subsystems simplifies simulations into unique, isolated control loops, each of which has a source, a transport, and a sink.

A source is a component that generates or provides heat, air, or some other state. It may be thought of a point or area that acts as a supplier or originator of the specified state. Two examples are heat sources and air sources. A heat source may be one that generates or emits heat such as a furnace, a heat pump, an electrical heater, or another source of heat. An air source introduces or supplies air. This may be an air handling unit, a fans or other devices that contribute to the circulation of air within the system.

A transport refers to some device that moves or transports state (such as, e.g., heat, moisture, air, sound, fluid, energy, fuel, controlled transport) within a controlled space. Controlled transport may consist of such devices as fans, pumps, valves, and dampers. These manage the flow of state through a controlled system.

A sink is a component within a control system where state is absorbed or otherwise removed. It may be thought of as a point or area that acts as a receptacle for energy, air, etc.

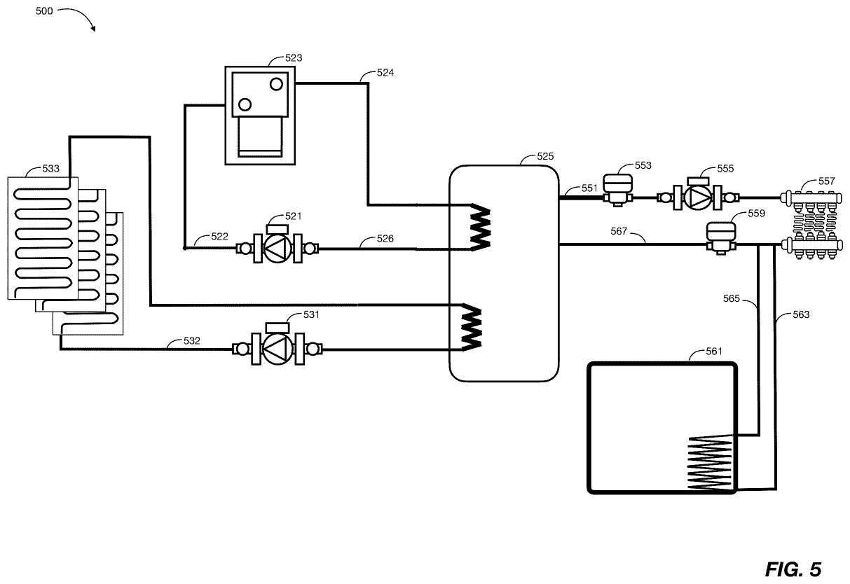

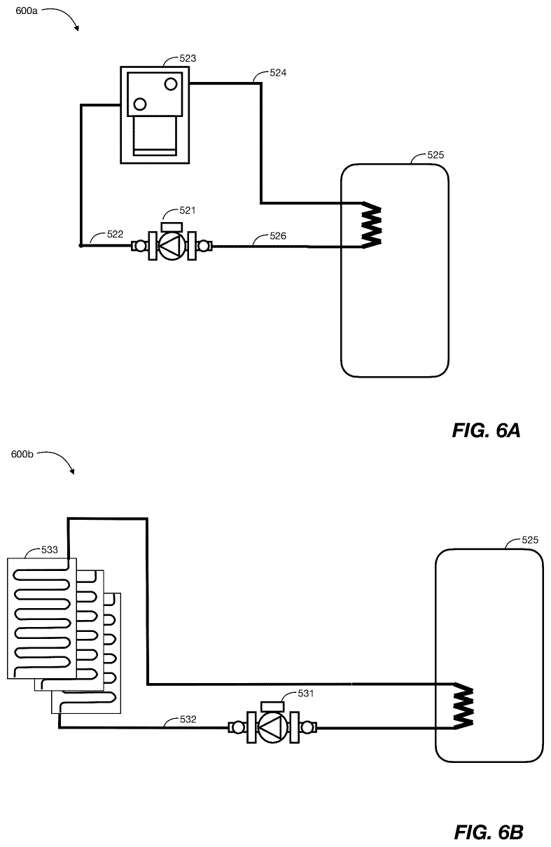

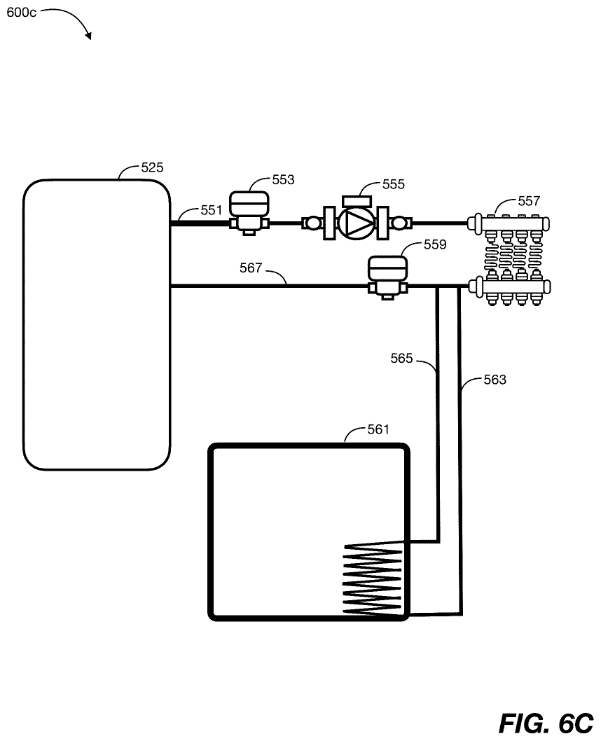

FIG. 5 illustrates a sample system 500 that is to be simulated. It includes a pump 521 (transport) that, using a pipe 522, which feeds into a boiler 523 (source), which, in turn, feeds into a storage tank 525 (sink). This system also includes another pump 531 (transport) which uses a pipe 532 to feed into radiant heaters 533 (source), which then feed into the same storage tank 525 (sink). Continuing, a pipe 551 feeds from the storage tank 525 (sink) to a two-way valve 553, which feeds into a pump 555 (transport), which feeds into a linker/manifold 557 (sink). That manifold feeds into both another two-way valve and then into the storage tank 525 (sink). Another path from the linker/manifold runs through pipe 563 to a heating tank 561 (source), and then from there from pipe 565, through the two-way valve 559, and then through the shared pipe 567 back to the storage tank (sink). This system may then be broken down into individual controllable loops that correspond to independent subsystems-discombobulation. The same components can be used in multiple subsystems. As large systems have mind-(and computer-) numbing complexity, breaking such a complex system down into subsystems may be required to be able to create a simulation that runs in some reasonable time. This allows, for example, a heating problem to be surgically dissected from a large system by ignoring the cooling system, etc. Example of subsystems that have been broken out of the system in FIG. 5 are shown in FIGS. 6A at 600a, 6B at 600b, and 6C at 600c. FIG. 6A shows a subsystem 600a with a source, the boiler 523; a transport, the pump 521 and a sink, the storage tank 525. FIG. 6B shows a subsystem 600b with a source, the radiant heaters 533, the transport pump 521, and the storage tank sink 525. FIG. 6C shows another subsystem 600c with a source, the heating tank 561, a transport, the valve 555, and two sinks, the storage tank 525, and the manifold 557. Various techniques for generating subsystems from a full system according to various embodiments, may be described in U.S. Pat. No. 10,708,078; the entire disclosure of which is hereby incorporated herein by reference. These subsystems—individual controllable loops—are also used, in some cases, to create and run a split-brain system.

The Weather Forecaster 460 takes available data on weather and keeps it up to date in the database 410. Atmospheric data is gathered from, e.g., local NOAA and other forecasts for the area, and ground weather and solar and shading effects around the building are simulated. Current weather data is gathered from a local weather station at the building if available. This information is then aggregated into a cohesive set of information that is ready for use in simulation.

The Distributed Work Engine 440 divides the work required for simulation among online controllers, as discussed with relation to the distributed controller system shown in FIG. 1 at 130 and the surrounding text. This distributed work engine 440 may control or assist the situation engine 436, which provides various sorts of simulation for modeled systems. Some of these simulations are a comfort model simulator 438, a building model simulator 440, and an equipment model simulator 442.

The comfort simulator 438 takes a multivalent approach to human (and non-human) comfort. Comfort Simulation models the idea of comfort based on what we know affects how comfortable people (animals, and objects) feel in certain conditions. Right now, wherever someone is, whether a person is comfortable isn't just a function of the room's temperature. It's also humidity and airflow. The type of clothing people wear this time of year at this latitude also has an affect. And the type of activities people engage in—a bingo hall is a very different scenario than a gymnasium. Temperature isn't enough. Knowing all aspects of human comfort is essential for predicting what will make a group of occupants comfortable in any given zone of a building. The type of activities occupants are engaged in within each zone at each time of day is used to estimate metabolic rate. Given the location on the earth, estimation is made about the types of clothing worn for these climate zones as well. Sensors may be used to detect how many people there are and when they frequent each zone. For example, to provide a cooling effect, the temperate may be lowered, the humidity reduced, or airflow increased. Instead of one temperature, one level of humidity, or one airflow setting, there is a multi-dimensional set of combinations of these settings that will make people comfortable. The chosen solution to get inside this comfort solution space and stay there as long as the zone is occupied. Comfort is a simulation rather than a simple values assessment. It is stochastic by nature and as such, cannot be fully known. When and where people will use different parts of the building and how they'll experience comfort in those settings cannot be perfectly predicted. So the probabilities of certain comfort scenarios occurring are simulated, and control paths that best meet the needs of the most likely comfort scenarios are created.

A building simulator, in some embodiments, simulates heat transfer for building components and zones. Building Simulator takes the model of the building, current environmental data, human comfort metrics, and weather forecasts to run experiments into the future millions of times per second. It tries different control decisions in simulation, tests the outcome, and logs the results. This process determines the loads on the various spaces within the building in the coming hours and days. “Loads” means looking for the ways the weather, ground, people, and adjacent spaces will cause heat to flow in and out of the various spaces in the building. As the Building Simulator completes load calculations of the heating and cooling needs throughout the different zones, it passes this information to the Equipment Simulator to determine what to do to address those loads.

An equipment simulator 442 replicates movement of fluids and energy between components and systems. In some embodiments, the Equipment Simulator 442 takes the results and calculated loads from Building Simulator and runs simulations on the equipment to determine how to best offset those loads. In other words, the Building Simulator finds the heating and cooling requirements a building's different spaces will have in the coming hours and days. The Equipment Simulator then runs simulations to match those heating and cooling needs with the equipment and systems that can meet them in real life.

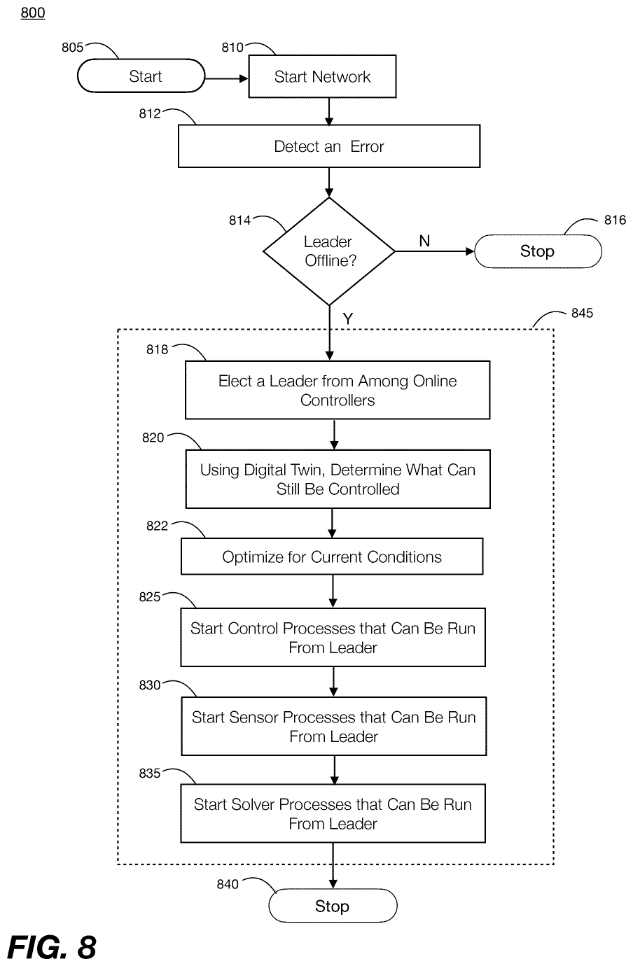

FIG. 8 illustrates methods for recovering at least a portion of a network system when at least part of the system has done the equivalent of going down. The system may have an error that makes a portion of the network impossible to run, such as a network outage, equipment breakage, etc. The operations of method 800 presented below are intended to be illustrative. In some embodiments, method 800 may be accomplished with one or more additional operations not described, and/or without one or more of the operations discussed. Additionally, the order in which the operations of method 800 are described below is not intended to be limiting.

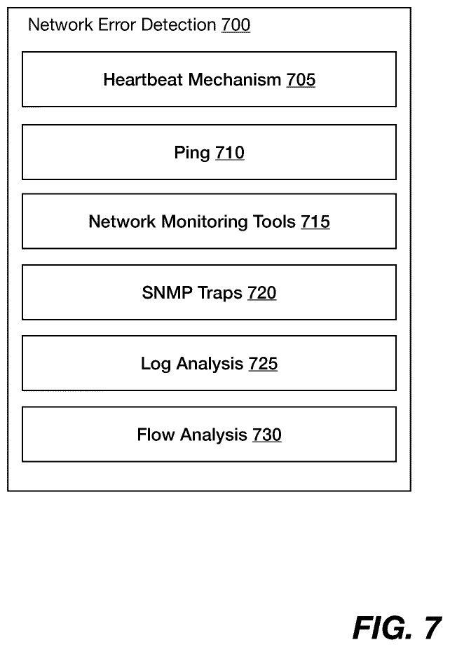

The method begins in step 805 and proceeds to step 810, where the network system starts up. This may involve a system-wide process supervisor 420 selecting a leader from among controllers available, may involve the available controllers electing a leader, or a different method of selecting a leader. Other typical network startup functions such as powering up devices, initializing hardware, etc. are performed. At step 812 an error is detected. This error may be detected by a single controller, a leader controller, etc. More information about error detection is discussed with reference to FIG. 7. Error detection happens throughout the time that a network is running.

At step 814, the error is analyzed to determine if it is one that has made the network unstable, such as having the controller leader offline. In some embodiments, if the controller leader is online, then the method continues to step 816, and the method stops. In some embodiments, other error analyses are used.

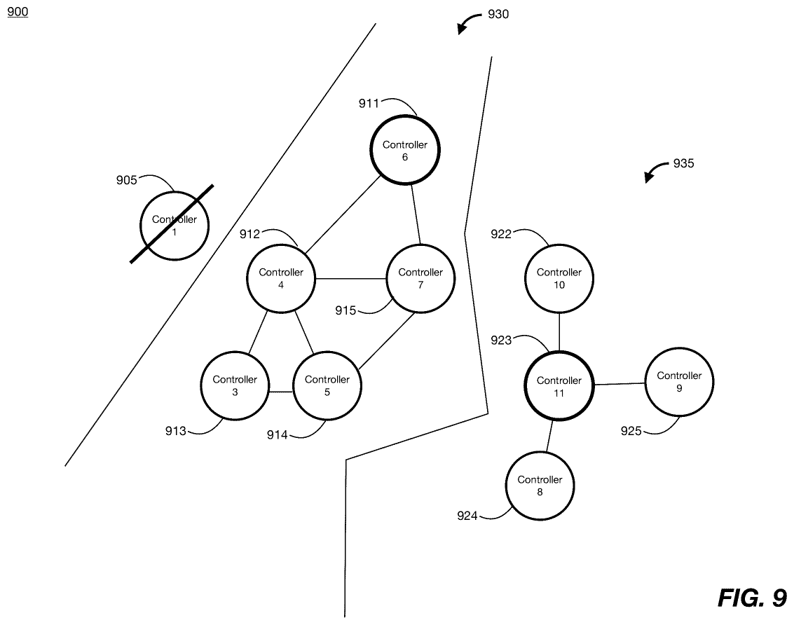

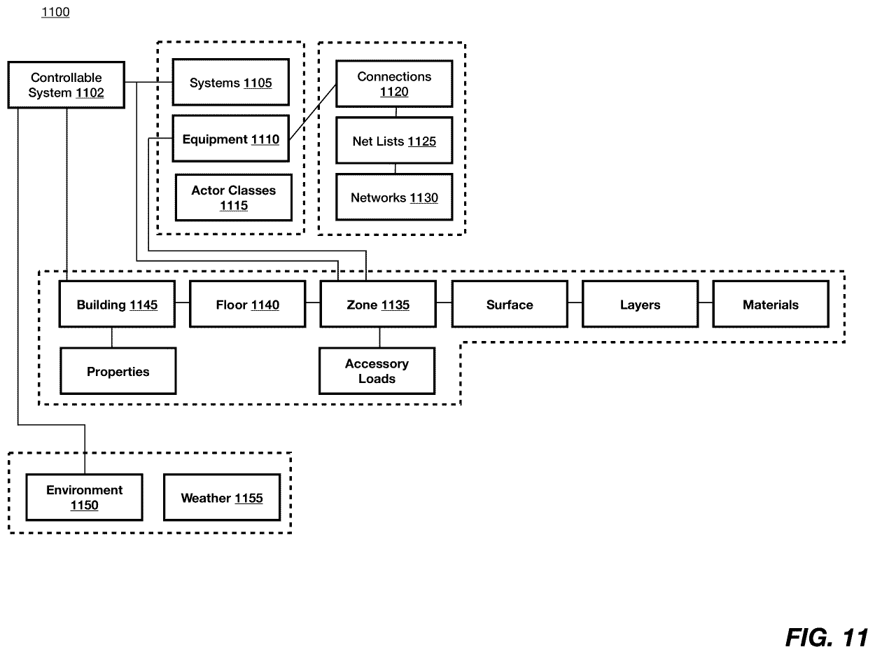

If the leader is offline, then at step 818 a leader is elected from among the controllers that can still communicate with each other. It could be that the system has been partitioned, and there are multiple controllers that can connect to some, but not all controllers. These controllers may be in two, three, or some other number of partitions, each able to connect with a select selection of controllers, but not others. In such case, each partition elects a leader and follows the steps 818-835, as shown by the outline 845. Some aspects of multiple leader election is described with relation to FIG. 9. For each leader, once the leader is selected 818, using information stored in the system, what parts of each partition that can still be controlled is determined. Due to the interconnected nature of the digital twin system, this can be determined even when connection to parts of the system is lost. Each controller has a database that shows the entire system interconnectivity as shown with reference to FIG. 11. Each leader then identifies, using connectivity tests, and the information contained in the digital twin, which subsystems it is capable of controlling, that is, for which subsystems in the full network can the leader still communicate with all of the involved equipment. For example, with reference to FIG. 6, if controller 2 1035 and controller 3 1040 are not in the same partition, then subsystem 3 will not be controlled by anyone. It will be shut down for the length of the partition. In some embodiments, if a subsystem requires more than one controller to control, even if both controllers are in the same partition, the subsystem is not run. In such a case, subsystem 3 will not be run even if both controllers are in the same partition.

At step 822, the simulations and the actual running of any controlled space 120 associated with the controllable system 130 by the various partitioned networks is optimized. The network and equipment monitor 425 identifies the external equipment interfaces that can be connected to. Based on the equipment that can be controlled (see, e.g., FIG. 11), the comfort simulator 438 may determine what the appropriate comfort levels exist in the areas that a given partition may control. Then, the control path predictor 435 looks at the comfort information as generated by the comfort simulator to run the building simulator 440 and equipment simulator 442 to determine an optimal control path from among control paths generated. The control path predictor may also take into account information from the weather forecaster to predict the future building environment, which may also be used by the building simulator 440 and the equipment simulator 442.

Once a control partition has determined a control path to follow, at step 825 the partition controller leader may determine which control processes can be run from the leader of the partition, determine that they are stopped, and then restart them. This may prevent controller contention between different partitions, and gives a single source of truth for control decisions. One reason this works is because equipment that can be controlled by two controllers, which might be in different partitions, is disallowed. At step 830, the partition controller leader determines which sensors it can run, and then starts them. Sensors are generally connected to a single controller. If one or more sensors is able to be controlled by multiple controllers, then it is turned off for the duration of the partition. At step 835, the partition leader then determines what solver processes can be run. This may present over-use of CPU resources, such as by multiple partitions that attempt to run the same solver processes, and provides a single source of truth for control decisions. Then, when all of the partitions have performed steps 181-835, at 840, the method stops.

FIG. 7 illustrates some types of network error detection 700 which may be used in methods and systems taught herein, such as in the recognize an error step 812 in FIG. 8. Detecting a network crash or failure in a system involves monitoring various aspects of the network to identify abnormal behavior or disruptions. A heartbeat mechanism 705 may regularly send signals or messages between network devices. If a device fails to receive the expected heartbeat within a specified time frame, it can infer that there might be a network issue or a device failure. Continuous or periodic pinging 710 of devices on the network using Internet Control Message Protocol (ICMP) can help detect network issues. If a device fails to respond to pings, it could indicate a network crash or a problem with that specific device. Network monitoring tools 715 may be used which are designed to continuously analyze network traffic and performance. These tools can generate alerts or notifications when abnormal patterns or disruptions are detected. Simple Network Management Protocol (SNMP) may be used to monitor and manage network devices. These SNMP traps 720 are messages sent by a device to a management station when specific events occur. An SNMP trap indicating a device or network failure can trigger an alert. Performing log analysis 725 by examining log files generated by network devices and servers can provide insights into network health. Unusual patterns, error messages, or a sudden absence of expected log entries may indicate a network crash. Performing flow analysis 730 by analyzing network flows, which include the source, destination, and type of traffic, can help identify anomalies. Sudden drops or changes in network flow may be indicative of a network crash. Other methods may be used as well.

FIG. 9 illustrates some types of a system where multiple controllers can connect only with parts of a partitioned network 900. A network partition occurs when a network is divided into separate segments, and these segments are unable to communicate with each other. Controller 1 905 is down. Controllers 3-7 911, 912, 913, 914, 915 can communicate only with each other, and controllers 8-11 922, 923, 924, 925 can also communicate only with themselves. This leads to separate isolated segments, segment 1 930 and segment 2 935. In some embodiments partition 1 930 and partition 2 935 will elect their own leader from among the controllers that they can contact. This may occur through a leader election system 427 that is itself controlled by the network and equipment monitor 425. These might exist on each controller, so loss of network connection is not a problem. This system, then, may have two leaders. Other systems may have more. Among other problems, this might lead to inconsistent data as the data may be replicated among multiple controllers that cannot now communicate, with the replicated data being randomly updated, leading to the replicated data being unusable unless measures are taken such as presented herein.

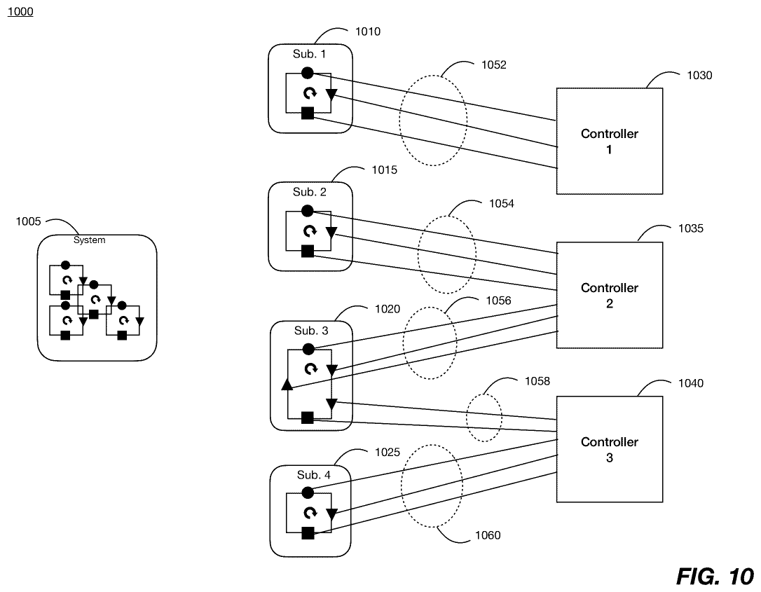

FIG. 10 illustrates different sorts of controller-device connections 1000. A system 1005 can be discombobulated into separate subsystems, as discussed with reference to FIG. 4 at 455, FIGS. 5, 6A-6C, and the surrounding text. In FIG. 10, these subsystems are subsystem 1 1010, subsystem 2, 1015, subsystem 3 1020, and subsystem 4 1025. Each of these subsystems include devices that are connected to controllers. All of subsystem 1 1010 devices are connected 1052 to the same controller, controller 1 1030, and thus can all be controlled by the same controller. Similarly, all of subsystem 2 1015 devices are connected 1054 to controller 2, and subsystem 4 1025 devices are connected 1060 to controller 3 1040. However, subsystem 3 has devices connected to both controller 2 1035 through the connections 1056 and controller 3 1060 through the connections 1060. These multi-controller subsystems (e.g., subsystem 3 1020) may be treated differently when a network has at least partially gone down. For example, in some embodiments, the multi-controller subsystems may not be used when the network goes down and a partition happens. This may mean that they are shut down, not restarted (when appropriate), etc.

FIG. 1100 illustrates some database features 226, 410 that form part of a digital twin 220, 400 system that can be used by each controller that is a part of the distributed controller system 130, 1102. The database features shown 1100 illustrate only a portion of the features that are available. Each controller has a database that includes the systems 1105, equipment 1110, and the connections 1120 to a specific controller. The database also includes an actor class 1115 which marks each piece of equipment as a transport, sink, or source, thus allowing the separate subsystems to be determined. The net lists 1125 and networks 1130 stored in the database allow a given controller to look at the list of controllers it can reach and make assumptions about the controllers that it cannot reach. The equipment 1110 can be associated with the specific zones 1135 in a controllable system 120, 1102, which, in turn, is connected to floors 1140 of a specific building 1145. The environment 1150 of the controllable system and the weather 1155, either expected, or overall, can also be determined. Using this information, the subset of a controllable system 1102 that can be controlled by the controllers in a partition can be determined.

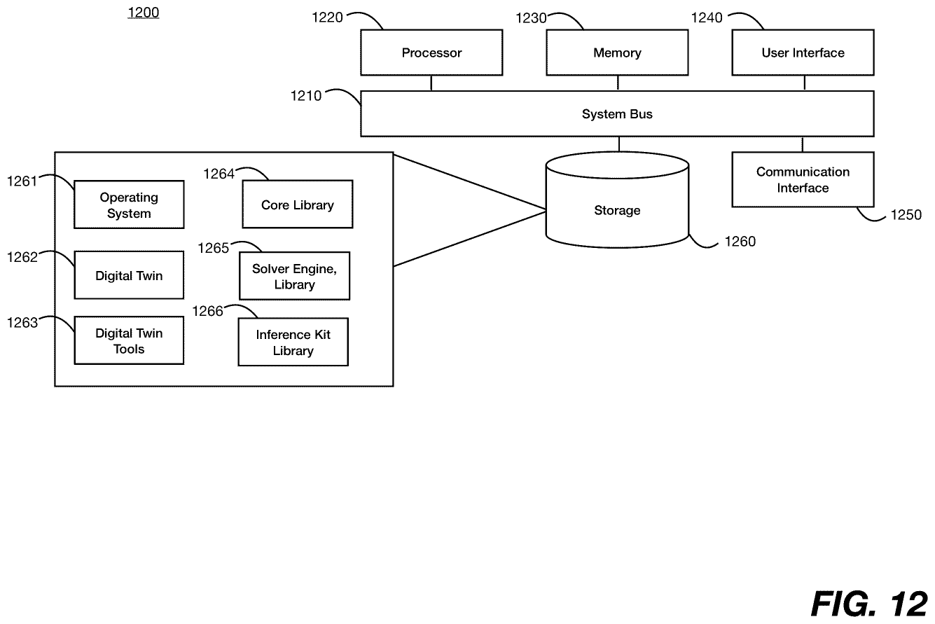

FIG. 12 illustrates an example hardware device 1200 for implementing a split brain self-healing process. The hardware device 1200 may describe the hardware architecture and some stored software for implementation of implementing a split brain self-healing process. As shown, the device 1200 includes a processor 1220, memory 1230, user interface 1240, communication interface 1250, and storage 1260 interconnected via one or more system buses 1210. It will be understood that FIG. 12 constitutes, in some respects, an abstraction and that the actual organization of the components of the device 1200 may be more complex than illustrated.

The processor 1220 may be any hardware device capable of executing instructions stored in memory 1230 or storage 1260 or otherwise processing data. As such, the processor 1220 may include a microprocessor, field programmable gate array (FPGA), application-specific integrated circuit (ASIC), or other similar devices.

The memory 1230 may include various memories such as, for example L1, L2, or L3 cache or system memory. As such, the memory 1230 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 1240 may include one or more devices for enabling communication with a user such as an administrator. For example, the user interface 1240 may include a display, a mouse, a keyboard for receiving user commands, or a touchscreen. In some embodiments, the user interface 1240 may include a command line interface or graphical user interface that may be presented to a remote terminal via the communication interface 1250 (e.g., as a website served via a web server).

The communication interface 1250 may include one or more devices for enabling communication with other hardware devices. For example, the communication interface 1250 may include a network interface card (NIC) configured to communicate according to the Ethernet protocol. Additionally, the communication interface 1250 may implement a TCP/IP stack for communication according to the TCP/IP protocols. Various alternative or additional hardware or configurations for the communication interface 1250 will be apparent.

The storage 1260 may include one or more machine-readable storage media such as read-only memory (ROM), random-access memory (RAM), magnetic disk storage media, optical storage media, flash-memory devices, or similar storage media. In various embodiments, the storage 1260 may store instructions for execution by the processor 1220 or data upon with the processor 1220 may operate. For example, the storage 1260 may store a base operating system 1261 for controlling various basic operations of the hardware 1200.

The storage 1260 additionally includes a digital twin 1262, such as a digital twin according to any of the embodiments described herein. As such, in various embodiments, the digital twin 1262 includes a heterogeneous and omnidirectional Digital twin tools 1263 may provide various functionality for modifying the digital twin 1262 and, as such, may correspond to a digital twin modifier or generative engine. Application tools may include various libraries for performing functionality for interacting with a digital twin 1262, as noticing error functions, starting and stopping processes, identifying and polling sensing data, determining if the given device 1200 is a network leader or a follower, etc.

The storage 1260 may also include one or more local data store core libraries 1264. The local data store may have a means for accessing the system library that is synched in a manner that it does not go out of date during a system partition. This may ensure that every device 1200 in a larger system is reading data that has been synchronized across the entire system.

A solver engine and library 1265 may also be included. The solver engine runs control recipes and conducts simulations of possible future control paths. It receives a package of information—building model, equipment models, occupant needs, current state, and desired building outcomes—and runs optimization simulations across the future states of the building, or the portion of the building that belongs to a current network partition. This process is based on gradient descent, a method for discovering minima across a graphical state space. While multiple solutions may be possible, the solver engine looks for the one that most closely meets the goals for the building or portion thereof over the simulated time period.

An Inference Kit Library 1266 may be included. This may allow the digital twins to understand more than what can be directly observed. This is especially important in split-brain systems where a portion of the system is invisible to other portions. To have a complete model, we can't measure everything that's happening in our buildings. This is especially true when only a portion of the building can be observed as happens during a split brain partition. The AI may be used to fill in the gaps. For example, what if the lead controller needs to know the temperature of a room but don't have access to a sensor to measure it? InferenceKit allows simulation of what the value in that room should be based off adjacent known values. The inference kit is flexible in its approach—and, therefore, more accurate and complete—because it's based on an omni-directional graph model. This is unique from traditional deep learning models, which can move only in one direction throughout a data structure and are more limited in inferencing capability. With an omni-directional graph model, if the temperature in a room needs to be known when it can't directly be measured, it can be inferred from multiple directions. The nearest known temperatures may be inferred based on how the equipment is heating or cooling the space, historical information, or the outside weather.

While the hardware device 1200 is shown as including one of each described component, the various components may be duplicated in various embodiments. For example, the processor 1220 may include multiple microprocessors that are configured to independently execute the methods described herein or are configured to perform steps or subroutines of the methods described herein such that the multiple processors cooperate to achieve the functionality described herein, such as in the case where the device 1200 participates in a distributed processing architecture with other devices which may be similar to device 1200. Further, where the device 1200 is implemented in a cloud computing system, the various hardware components may belong to separate physical systems. For example, the processor 1220 may include a first processor in a first server and a second processor in a second server.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

We claim:

1. A method for a controller controlling at least a portion of a system with a network failure, the method comprising:
receiving word of a network failure;
receiving election as leader of a partition;
determining subsystems completely in the partition;
starting control processes for equipment in the subsystems completely in partition; and
starting sensor processes for equipment in the subsystems completely in partition.

2. The method of claim 1 wherein determining subsystems completely in partition further comprises using a digital twin database stored within the controller to determine subsystems.

3. The method of claim 2, wherein determining subsystems completely in partition comprises determining controllers that can be communicated with.

4. The method of claim 3, wherein determining subsystems completely in partition further comprising determining subsystems within the controllers that can be communicated with creating determined subsystems.

5. The method of claim 3, wherein determining subsystems completely in partition further comprising determining subsystems whose devices are on a single controller, creating determined subsystems.

6. The method of claim 5, further comprising determining areas in a controllable space that can be controlled by the controller.

7. The method of claim 6, further comprising determining comfort levels for the areas in the controllable space that can be controlled by the controller.

8. The method of claim 7, further comprising determining control paths for the areas in the controllable space that can be controlled by the controller.

9. The method of claim 8, further comprising starting the control processes associated with the determined subsystems.

10. The method of claim 9, further comprising starting the sensor processes within the determined subsystems.

11. A device for controlling at least a portion of a system with a network failure, comprising:
a memory storing a digital twin representing a physical space; and
a processor configured to:
receive word of a network failure;
receive election as leader of a partition;
determine subsystems completely in the partition;
start control processes for equipment in the subsystems completely in partition; and
start sensor processes for equipment in the subsystems completely in partition.

12. The device of claim 11 wherein the determine subsystems completely in partition further comprises using a digital twin database stored within the controller to determine subsystems.

13. The device of claim 12, wherein the determine subsystems completely in partition comprises determining controllers that can be communicated with.

14. The device of claim 13, wherein the determine subsystems completely in partition further comprising determining subsystems within the controllers that can be communicated with creating determined subsystems.

15. The device of claim 13, wherein the determine subsystems completely in partition further comprising determining subsystems whose devices are on a single controller, creating determined subsystems.

16. A non-transitory machine-readable storage medium encoded with instructions for execution by a processor for capturing digital twin information performed by a processor, the non-transitory machine-readable medium comprising:
instructions for receiving word of a network failure;
instructions for receive election as leader of a partition;
instructions for determining subsystems completely in the partition;
instructions for starting control processes for equipment in the subsystems completely in partition; and
instructions for starting sensor processes for equipment in the subsystems completely in partition.

17. The non-transitory machine-readable storage medium of claim 16 wherein instructions for determining subsystems completely in partition further comprises instructions for using a digital twin database stored within the controller to determine subsystems.

18. The non-transitory machine-readable storage medium claim 17, wherein instructions for determining subsystems completely in partition comprises instructions for determining controllers that can be communicated with.

19. The non-transitory machine-readable storage medium of claim 18, wherein instructions for determining subsystems completely in partition further comprising instructions for determining subsystems within the controllers that can be communicated with creating determined subsystems.

20. The non-transitory machine-readable storage medium of claim 18, wherein instructions for determining subsystems completely in partition further comprising instructions for determining subsystems whose devices are on a single controller, creating determined subsystems.
